(19) United States
(12) Patent Application Publication
(10) Pub. No.: US 2025/0358614 A1
(43) Pub. Date: Nov. 20, 2025

(54) BIOMETRIC VERIFICATION SYSTEMS AND METHODS

(71) Applicant: 5010 Tech, LLC, Vienna, VA (US)

(72) Inventor: Steve Battjer, Vienna, VA (US)

(21) Appl. No.: 19/045,235

(22) Filed: Feb. 4, 2025

Related U.S. Application Data
(60) Provisional application No. 63/648,095, filed on May 15, 2024.

(51) Int. Cl. H04W 12/06

(52) U.S. Cl. CPC H04W 12/068

(57) ABSTRACT

Techniques for monitoring individuals, including: a peer device to obtain, from a watchlist data source, first watchlist data concerning a first set of individuals of interest, the first watchlist data including biometric characteristics for the first set of individuals of interest; obtain, by way of a biometric sensor of the peer device, first biometric data for a first individual; determine, based on comparison of the first biometric data to the biometric characteristics, a first threat level for the first individual; generate, a first access control data entry for the first individual, the first access control data entry including an indication of the first biometric data; send, to other of the peer devices by way of peer-to-peer synchronization, first access control data including the first access control data entry; send, to an access control system, the first access control data entry.

### RELATED APPLICATIONS

This application claims benefit of and priority to U.S. Provisional Patent Application No. 63/648,095 filed May 15, 2024, and titled “BIOMETRIC VERIFICATION SYSTEMS AND METHODS,” which is hereby incorporated by reference in its entirety.

### GOVERNMENT LICENSE RIGHTS

This invention was made with government support under Contract Number 47QFCA22D0357, Task Order 47QFCA23F0014 awarded by the General Services Agency. The government has certain rights in the invention.

### FIELD

Embodiments relate generally to employing biometrics for monitoring and verifying status of individuals and more particularly to monitoring and verifying status of individuals using biometric data synchronized by way of peer to peer networks.

### BACKGROUND

Monitoring individuals can be advantageous in various contexts, such as in military operations where knowledge and security are paramount. For example, using advanced biometric matching techniques, such as facial recognition and fingerprint analysis, personnel can efficiently and effectively identify and track individuals of interest within complex environments. Such monitoring capability can help to minimize the risk of infiltration by adversaries, facilitates the apprehension of threats, enhances knowledge and situational awareness, enables real-time adjustments to strategies, improves operational effectiveness, safeguards the well-being of personnel, and the like.

### SUMMARY

In many instances, monitoring and verification of individual persons is accomplished based on personal knowledge or reference to information concerning one or more individual persons. For example, in the context of a military operation that includes screening persons at a given location, a soldier may interact with persons, one-by-one, relying on personal knowledge of bad actors or other information concerning bad actors, such as a watchlist, to identify persons that are considered threats. In some instances, additional technologies, such as biometrics, are employed to further enhance the ability to screen individuals quickly and effectively. For example, continuing with the military context, military personnel may be outfitted with biometric sensing devices, such as fingerprint scanners, retinal scanners, facial scanners, or the like, that are used to collect biometric information which can be used to identify individuals and, in turn, determine whether individuals are a threat, whether further actions concerning individuals are required, and so forth.

Although advanced identification techniques, such as biometrics, are useful, they are often limited by the amount, type, and quality of information that is available. For example, if various regions have different watchlists, perhaps due to delays in dissemination of information, the watchlist for a first region may list an individual as a threat while a watchlist for a second region may not list an individual as a threat. As a result, despite military personnel in the second region encountering and properly identifying the individual using biometrics, the personnel may allow the individual to proceed without restriction despite the individual being a known threat. In some instances, centralized sets of information are developed to combat disparate and incomplete information. For example, the U.S. Department of Defense (DoD) has developed a centralized database of information, often referred to as a “biometrically-enabled watchlist” (BEWL) or “defense watchlist,” that integrates biometric data, such as facial images, fingerprints, palm prints, iris scans, voice scans, or other unique physiological traits, with associated identifying information, such as names, aliases, and demographic details. Such a watchlist can serve as a relatively complete tool for identifying and tracking individuals of interest or concern in various contexts, including military operations, law enforcement, border security, and counterterrorism operations. Continuing with the military context example, a BEWL constructed based on a large corpus of shared data may be disseminated across military personnel for use in identifying individuals across different regions and contexts. In the case of a soldier conducting a biometric scan of an individual, the individual's biometric traits, such as fingerprints, may be compared to a relatively complete set of known biometrics found in the BEWL. If no match is found, the soldier may simply continue processing the individual in normal course (e.g., “checking in” the individual). If a match is found, the soldier may be provided with information concerning the individual, such as a threat level (e.g., low threat, moderate threat, high threat, or the like), an action to be taken (e.g., separate from general population, detain, alert authorities, deny access, etc.), or the like. The soldier may, in turn, proceed to process the individual in accordance with the information (e.g., detaining the individual and sending an alert to authorities).

Although centralized and biometrically-enabled watchlists (“BEWLs”) and similar types of biometric identification techniques can be relatively effective, they often suffer from limitations that can reduce effectiveness. For example, in the case of a BEWL, if the BEWL is incomplete, out-of-date, or otherwise inaccurate, the associated biometric screening process may be compromised. For instance, where a version of a BEWL provided to military personnel fails to identify an individual recently identified as a threat, despite military personnel encountering and properly identifying the individual using biometrics, the personnel may not be alerted to the threat posed by the individual and, as a result, allow the individual to proceed without restriction despite the individual being a known threat. As another example, even if a “master” BEWL is up to date, if a “local” version available to a set of military personnel is not up-to-date, screenings conducted by the set of military personnel may be compromised. For example, if a first version of BEWL is downloaded based on a current master version of the BEWL maintained on a server and provided to set of military personnel, and the master BEWL is updated to a second version, but the second version of the BEWL is not disseminated or otherwise provided to the set of military personnel, the military personnel may conduct biometric screenings based on out-of-date information of the first version of the BEWL.

Provided are improved systems and methods for monitoring and verifying status of persons using centralized watchlists (e.g., a BEWL or other watchlist) and biometric data (e.g., fingerprints, retinal mappings, facial mappings, voice mappings, or the like). In some embodiments, persons are identified using biometric data synchronized by way of peer to peer (P2P) networks. For example, a watchlist may be provided from a watchlist source to a peer device of a group of peer devices, and the watchlist may be provided to some or all the other peer devices by way of peer-to-peer (“P2P”) synchronization of the watchlist across the group of peer devices. For example, a BEWL may be provided from a BEWL source (e.g., a DoD server) to a first mobile device (e.g., in the possession of a first soldier) of a group of peer mobile devices (e.g., that are in the possession of a first group of soldiers that includes the first soldier) by way of a client-server communications network, such as the Internet, and the watchlist may be provided from the first mobile device to some or all of the other peer mobile devices by way of a P2P synchronization operation, resulting in each of the mobile devices of the group of peer mobile devices having a local copy of the BEWL stored thereon. A similar P2P synchronization operation may be conducted as any of the mobile devices receive an updated version of the BEWL to keep those devices up to date.

In some embodiments, an operator of a peer device employs their respective peer device to obtain subject data concerning an individual, and compares the subject data to the watchlist or other relevant information stored on, or otherwise accessible by, the peer device to determine a status of the individual, such as whether the individual is already identified in the watchlist or the other relevant data, a status for the individual, an action for the individual, or the like. Continuing with the above example, one of the soldiers having a mobile device with a BEWL may employ the mobile device to obtain subject data concerning an individual (e.g., obtain biometric data, such as fingerprints, of the individual, biographic data, such as a name of the individual, or the like), and compare the obtained subject data to data from the BEWL (or “watchlist data”) concerning monitored individuals (e.g., biometric data and biographic data for many individuals) to determine a status of the individual, such as a status for the individual (e.g., low/moderate/high threat level), an action for the individual (e.g., separate from general population, detain, alert authorities, deny/allow access, etc.) or the like. In such an embodiment, the status of the individual may inform how the individual is to be processed or otherwise interacted with. For example, the soldier of the preceding example may, in response to being presented with a status of “high threat level+detain,” proceed to detain the individual, taking precautions appropriate for a high threat individual.

In some embodiments, relevant data is obtained and synchronized by way of P2P networks. For example, where an individual is encountered (e.g., in the process of screening job applicants, personnel check-in operations, or the like) and subject data concerning the individual is obtained, the subject data may be recorded on a peer device and be disseminated to some or all other co-located peer devices by way of P2P synchronization. For example, in response to a soldier encountering an individual, the soldier may collect subject data that includes biometric data collected from the individual by way of a biometric sensor of the soldier's mobile device, including a fingerprint obtained by way of a fingerprint scanner of the soldier's mobile device, and biographic data collected for the individual, including a name, date of birth and status (e.g., boarded transport vehicle) for the individual, that is entered by the soldier via a user interface of the soldier's mobile device. In some instances, a threat assessment is conducted based on the subject data, for example, by comparing items of the subject data (e.g., such as the fingerprint, name and date of birth of the individual) to respective elements of watchlist data (e.g., from a BEWL) that is currently stored on the soldier's mobile device. If the subject data matches subject data of the watchlist data, a corresponding notice (e.g., including a threat alert) may be presented on the user interface of the soldier's mobile device, for viewing and follow-up by the soldier. If the subject data does not match the watchlist data, a corresponding notice (e.g., including a no-threat alert) may be presented on the user interface of the soldier's mobile device, for viewing and follow-up by the soldier. In response to obtaining the subject data, or completion of the threat assessment, the subject data may be logged and synchronized. Continuing with the above example, subject data (e.g., including the biometric and biographic data for the individual obtained) may be logged in an access control data entry stored on the soldier's mobile device, and may, in turn, be transmitted from the soldier's mobile device to some or all of co-located soldiers' mobile devices by way of a P2P synchronization operation. This may result in each of the of the co-located mobile devices of the group of peer mobile devices having a local copy of the subject data and other relevant access control data present in the access control data entry. Such synchronization may ensure that co-located peer devices have access to up-to-date versions of a watchlist (e.g., based on a BEWL) and up-to-date subject data.

In some embodiments, synchronization of data is conducted by way of peer-to-peer communication that is independent of communication across a client-server communications network. For example, responsive to a given peer device obtaining a data set to be synchronized, such as a watchlist and access control data entries, a P2P synchronization operation may involve P2P file sharing from the peer device to one or more other co-located peer devices by way of a suitable peer communication protocol, such as Bluetooth (e.g., Bluetooth Low Energy), Wi-Fi Direct (formerly Peer-to-Peer Wi-Fi), a local area network (LAN), cellular, or the like. Such P2P synchronization may enable synchronization of data without reliance on a client-server or similar communications network. For example, where a military unit is screening individuals in a remote location that is isolated from the Internet or the like, mobile devices of the soldiers in the unit may synchronize with one another to share a latest received version of watchlist data for the purpose of threat screening and to share updated access control data entries, including additions or edits, for the purpose of logging characteristics and the current status of individuals.

In some embodiments, watchlist data, such as a BEWL or a portion thereof, is obtained from a third party source, such as a DoD server, by way of an external communications network and is disseminated to co-located peer devices by way of P2P synchronization, and access control data obtained by way of one or more peer devices is disseminated to co-located peer devices by way of P2P synchronization and is transmitted to a third party destination, such as an access control system server, by way of an external communications network. For example, watchlist data that includes some or all of a BEWL may be provided from a BEWL source (e.g., a DoD server) to a first mobile device (e.g., in the possession of a first soldier) of a group of peer mobile devices (e.g., that are in the possession of a first group of soldiers that includes the first soldier) by way of a client-server communications network, such as the Internet, and the watchlist may be provided from the first mobile device to some or all of the other peer mobile devices by way of a P2P synchronization operation, resulting in each of the of the mobile devices of the group of peer mobile devices having a local copy of the watchlist data stored thereon. In response to a soldier encountering an individual, the soldier may collect subject data that includes biometric data collected from the individual by way of a biometric sensor of the soldier's mobile device, including a fingerprint obtained by way of a fingerprint scanner of the soldier's mobile device, and biographic data collected for the individual, including a name, date of birth and status (e.g., boarded transport vehicle) for the individual, that is entered by the soldier via a user interface of the soldier's mobile device. Access control data, such as an access control data entry (or “access control entry”), that includes the biometric and biographic data for the individual obtained and stored on the soldier's mobile device, may, in turn, be transmitted from the soldier's mobile device to some or all of co-located soldiers' mobile devices by way of a P2P synchronization operation, resulting in each of the of the co-located mobile devices of the group of peer mobile devices having a local copy of the subject data and other relevant access control data. Upon a mobile device having a local copy of a “new” access control data entry connecting to the Internet, the mobile device may conduct an access control data upload operation to transmit the “new” access control data entry to an access control system server, which may, in turn store the “new” access control data entry for use in future operations. In some embodiments, a peer device that generates an access control data entry is tasked with uploading that data to a destination. For example, in response to the soldier collecting “new” biometric and biographic data from the individual via the soldier's mobile device, the soldier's mobile device may generate a corresponding “new” access control data entry and conduct a peer synchronization operation to disseminate the “new” access control data entry to other co-located mobile devices associated with soldiers in the same unit. Upon the soldier's mobile device connecting to the Internet, for example, at a future time, the soldier's mobile device may conduct an access control data upload operation to send the “new” access control data entry to an access control server for use in updating associated access control data. In some embodiments, an access control server updates given access control data to reflect a most-recent version of the access control data. For example, where an entry for the same access control data is received as a first version from a first device and then as a second version from a second device, the access control server may store the second version as the current version of the given access control data based on it being deemed the most recent (e.g., based on a later timestamp, it being received later/last, or the like).

As described, certain embodiments can be employed in the context of biometric screening employed within a military context. Although certain embodiments are described in a given context for the purpose of illustration, embodiments may be employed in any suitable context. For example, certain embodiments may be employed for screening individuals to verify whether they are allowed access to a job, a facility, a resource, or the like.

Provided in some embodiments is an individual monitoring system including: a watchlist data source adapted to maintain a watchlist including watchlist data concerning individuals of interest, the watchlist data including respective sets of biometric characteristics associated with respective individuals of the individuals of interest; an access control system adapted to maintain access control data concerning monitored individuals, the access control data including respective sets of subject data associated with respective individuals of the monitored individuals, the sets of subject data including biometric characteristics and biographic characteristics of monitored individuals; and two or more peer devices adapted to communicate with one another by way of peer-to-peer communication, each of the peer devices associated with an operator, including a biometric sensor, and adapted to perform the following operations: obtain, from the watchlist data source by way of a client-server communications network, first watchlist data concerning a first set of individuals of interest, the first watchlist data including respective sets of biometric characteristics associated with respective individuals of the first set of individuals of interest; obtain, by way of the biometric sensor of the peer device, first biometric data for a first individual; determine, based on comparison of the first biometric data for the first individual to the biometric characteristics of the first watchlist data, a first threat level for the first individual; provide an indication of the first threat level for the first individual; generate a first access control data entry for the first individual, the first access control data entry for the first individual including an indication of the first biometric data for the first individual; send, to one or more other of the peer devices by way of peer-to-peer synchronization with the one or more other of the peer devices, first access control data including the first access control data entry for the first individual; send, to the access control system in response to determining a connection with the access control system and by way of a client-server communication network, the first access control data entry for the first individual; receive, by way of peer-to-peer synchronization with one or more other of the peer devices, second access control data; and receive, by way of peer-to-peer synchronization with one or more other of the peer devices, second watchlist data.

In some embodiments, the watchlist includes a biometrics-enabled watchlist (BEWL), and the first watchlist data corresponds to at least a portion of the BEWL. In certain embodiments, the peer-to-peer synchronization between peer devices includes: transmitting, by a receiving peer device to a sending peer device, a query for data; and transmitting, by the sending peer device to the receiving peer device responsive to the query, data. In some embodiments, the peer device includes a mobile communications device and the peer-to-peer synchronization with one or more other of the peer devices is accomplished by way of wireless communication. In certain embodiments, the peer-to-peer synchronization of data between peer devices is accomplished without transmission of the data to a server of a client-server based communications network. In some embodiments, the watchlist data source includes a database including the watchlist, and where the access control system includes a database including access control data entries and adapted to store, in the database, data corresponding to the first access control data entry for the first individual. In certain embodiments, the indication of the first threat level for the first individual includes an action to be taken by a first operator associated with the peer device. In some embodiments, the action to be taken includes detaining the first individual. In certain embodiments, the action to be taken includes providing the first individual with access to one or more resources or opportunities.

Provided in some embodiments is a method for monitoring individuals, including: obtaining, by a peer device from a watchlist data source by way of a client-server communications network, first watchlist data concerning a first set of individuals of interest, the watchlist data source maintaining a watchlist including watchlist data concerning individuals of interest, the watchlist data including respective sets of biometric characteristics associated with respective individuals of the individuals of interest, the first watchlist data including respective sets of biometric characteristics associated with respective individuals of the first set of individuals of interest, communicating, the peer device adapted to communicate with other peer devices by way of peer-to-peer communication, the peer device associated with an operator, including a biometric sensor; obtaining, by the peer device by way of the biometric sensor of the peer device, first biometric data for a first individual; determining, by the peer device based on comparison of the first biometric data for the first individual to the biometric characteristics of the first watchlist data, a first threat level for the first individual; providing, by the peer device, an indication of the first threat level for the first individual; generating, by the peer device, a first access control data entry for the first individual, the first access control data entry for the first individual including an indication of the first biometric data for the first individual; sending, by the peer device to one or more other of the peer devices by way of peer-to-peer synchronization with the one or more other of the peer devices, first access control data including the first access control data entry for the first individual; sending, by the peer device to an access control system in response to determining a connection with the access control system and by way of a client-server communication network, the first access control data entry for the first individual, the access control system adapted to maintain access control data concerning monitored individuals, the access control data including respective sets of subject data associated with respective individuals of the monitored individuals, the sets of subject data including biometric characteristics and biographic characteristics of monitored individuals; and receiving, by the peer device by way of peer-to-peer synchronization with one or more other of the peer devices, second access control data; and receiving, by the peer device by way of peer-to-peer synchronization with one or more other of the peer devices, second watchlist data.

In some embodiments, the watchlist includes a biometrically enabled watchlist (BEWL), and the first watchlist data corresponds to at least a portion of the BEWL. In certain embodiments, the peer-to-peer synchronization between peer devices includes: transmitting, by a receiving peer device to a sending peer device, a query for data; and transmitting, by the sending peer device to the receiving peer device responsive to the query, data. In some embodiments, the peer device includes a mobile communications device and the peer-to-peer synchronization with one or more other of the peer devices is accomplished by way of wireless communication. In certain embodiments, the peer-to-peer synchronization of data between peer devices is accomplished without transmission of the data to a server of a client-server based communications network. In some embodiments, the watchlist data source includes a database including the watchlist, and where the access control system includes a database including access control data entries and adapted to store, in the database, data corresponding to the first access control data entry for the first individual. In certain embodiments, the indication of the first threat level for the first individual includes an action to be taken by a first operator associated with the peer device. In some embodiments, the action to be taken includes detaining the first individual. In certain embodiments, the action to be taken includes providing the first individual with access to one or more resources or opportunities.

Provided in some embodiments is a non-transitory computer readable storage medium including program instructions stored thereon that are executable by a processor to cause the following operations for monitoring individuals: obtaining, by a peer device from a watchlist data source by way of a client-server communications network, first watchlist data concerning a first set of individuals of interest, the watchlist data source maintaining a watchlist including watchlist data concerning individuals of interest, the watchlist data including respective sets of biometric characteristics associated with respective individuals of the individuals of interest, the first watchlist data including respective sets of biometric characteristics associated with respective individuals of the first set of individuals of interest, communicating, the peer device adapted to communicate with other peer devices by way of peer-to-peer communication, the peer device associated with an operator, including a biometric sensor; obtaining, by the peer device by way of the biometric sensor of the peer device, first biometric data for a first individual; determining, by the peer device based on comparison of the first biometric data for the first individual to the biometric characteristics of the first watchlist data, a first threat level for the first individual; providing, by the peer device, an indication of the first threat level for the first individual; generating, by the peer device, a first access control data entry for the first individual, the first access control data entry for the first individual including an indication of the first biometric data for the first individual; sending, by the peer device to one or more other of the peer devices by way of peer-to-peer synchronization with the one or more other of the peer devices, first access control data including the first access control data entry for the first individual; sending, by the peer device to an access control system in response to determining a connection with the access control system and by way of a client-server communication network, the first access control data entry for the first individual, the access control system adapted to maintain access control data concerning monitored individuals, the access control data including respective sets of subject data associated with respective individuals of the monitored individuals, the sets of subject data including biometric characteristics and biographic characteristics of monitored individuals; and receiving, by the peer device by way of peer-to-peer synchronization with one or more other of the peer devices, second access control data; and receiving, by the peer device by way of peer-to-peer synchronization with one or more other of the peer devices, second watchlist data.

Provided in some embodiments is a system for monitoring individuals, including: a peer device adapted to perform the following operations: obtaining, from a watchlist data source, first watchlist data concerning a first set of individuals of interest, the first watchlist data including biometric characteristics for the first set of individuals of interest; obtaining, by way of a biometric sensor of the peer device, first biometric data for a first individual; determining, based on comparison of the first biometric data for the first individual to the biometric characteristics of the first watchlist data, a first threat level for the first individual; generating, a first access control data entry for the first individual, the first access control data entry for the first individual including an indication of the first biometric data for the first individual; sending, to one or more other of the peer devices by way of peer-to-peer synchronization with the one or more other of the peer devices, first access control data including the first access control data entry for the first individual; and sending, to an access control system, the first access control data entry for the first individual.

### BRIEF DESCRIPTION OF THE DRAWINGS

FIG. 1 is a diagram that illustrates a subject monitoring environment in accordance with one or more embodiments.

FIG. 2 is a diagram that illustrates an example subject monitoring environment that provides for transportation of subjects between locations in accordance with one or more embodiments.

FIG. 3 is a flowchart diagram that illustrates methods for subject monitoring in accordance with one or more embodiments.

FIG. 4 is a diagram that illustrates an example computer system in accordance with one or more embodiments.

While this disclosure is susceptible to various modifications and alternative forms, specific example embodiments are shown and described. The drawings may not be to scale. The drawings and the detailed description are not intended to limit the disclosure to the form disclosed, but are intended to disclose modifications, equivalents, and alternatives falling within the spirit and scope of the present disclosure as defined by the claims.

### DETAILED DESCRIPTION

Described are embodiments for monitoring and verifying status of individuals using centralized watchlists (e.g., a BEWL or other watchlist) and biometric data (e.g., fingerprints, retinal mappings, facial mappings, voice mappings, or the like). In some embodiments, persons are identified using biometric data synchronized by way of peer to peer (P2P) networks. For example, a watchlist may be provided from a watchlist source to a peer device of a group of peer devices, and the watchlist may be provided to some or all the other peer devices by way of peer-to-peer (“P2P”) synchronization of the watchlist across the group of peer devices. For example, a BEWL may be provided from a BEWL source (e.g., a DoD server) to a first mobile device (e.g., in the possession of a first soldier) of a group of peer mobile devices (e.g., that are in the possession of a first group of soldiers that includes the first soldier) by way of a client-server communications network, such as the Internet, and the watchlist may be provided from the first mobile device to some or all of the other peer mobile devices by way of a P2P synchronization operation, resulting in each of the mobile devices of the group of peer mobile devices having a local copy of the BEWL stored thereon. A similar P2P synchronization operation may be conducted as any of the mobile devices receive an updated version of the BEWL to keep those devices up to date.

In some embodiments, an operator of a peer device employs their respective peer device to obtain subject data concerning an individual, and compares the subject data to the watchlist or other relevant information stored on, or otherwise accessible by, the peer device to determine a status of the individual, such as whether the individual is already identified in the watchlist or the other relevant data, a status for the individual, an action for the individual, or the like. Continuing with the above example, one of the soldiers having a mobile device with a BEWL may employ the mobile device to obtain subject data concerning an individual (e.g., obtain biometric data, such as fingerprints, of the individual, biographic data, such as a name of the individual, or the like), and compare the obtained subject data to data from the BEWL (or “watchlist data”) concerning monitored individuals (e.g., biometric data and biographic data for many individuals) to determine a status of the individual, such as a status for the individual (e.g., low/moderate/high threat level), an action for the individual (e.g., separate from general population, detain, alert authorities, deny/allow access, etc.) or the like. In such an embodiment, the status of the individual may inform how the individual is to be processed or otherwise interacted with. For example, the soldier of the preceding example may, in response to being presented with a status of “high threat level+detain,” proceed to detain the individual, taking precautions appropriate for a high threat individual.

In some embodiments, relevant data is obtained and synchronized by way of P2P networks. For example, where an individual is encountered (e.g., in the process of screening job applicants, personnel check-in operations, or the like) and subject data concerning the individual is obtained, the subject data may be recorded on a peer device and be disseminated to some or all other co-located peer devices by way of P2P synchronization. For example, in response to a soldier encountering an individual, the soldier may collect subject data that includes biometric data collected from the individual by way of a biometric sensor of the soldier's mobile device, including a fingerprint obtained by way of a fingerprint scanner of the soldier's mobile device, and biographic data collected for the individual, including a name, date of birth and status (e.g., boarded transport vehicle) for the individual, that is entered by the soldier via a user interface of the soldier's mobile device. In some instances, a threat assessment is conducted based on the subject data, for example, by comparing items of the subject data (e.g., such as the fingerprint, name and date of birth of the individual) to respective elements of watchlist data (e.g., from a BEWL) that is currently stored on the soldier's mobile device. If the subject data matches subject data of the watchlist data, a corresponding notice (e.g., including a threat alert) may be presented on the user interface of the soldier's mobile device, for viewing and follow-up by the soldier. If the subject data does not match the watchlist data, a corresponding notice (e.g., including a no-threat alert) may be presented on the user interface of the soldier's mobile device, for viewing and follow-up by the soldier. In response to obtaining the subject data, or completion of the threat assessment, the subject data may be logged and synchronized. Continuing with the above example, subject data (e.g., including the biometric and biographic data for the individual obtained) may be logged in an access control data entry stored on the soldier's mobile device, and may, in turn, be transmitted from the soldier's mobile device to some or all of co-located soldiers' mobile devices by way of a P2P synchronization operation. This may result in each of the of the co-located mobile devices of the group of peer mobile devices having a local copy of the subject data and other relevant access control data present in the access control data entry. Such synchronization may ensure that co-located peer devices have access to up to date versions of a watchlist (e.g., based on a BEWL) and up to date subject data.

In some embodiments, synchronization of data is conducted by way of peer-to-peer communication that is independent of communication across a client-server communications network. For example, responsive to a given peer device obtaining a data set to be synchronized, such as a watchlist and access control data entries, a P2P synchronization operation may involve P2P file sharing from the peer device to one or more other co-located peer devices by way of a suitable peer communication protocol, such as Bluetooth (e.g., Bluetooth Low Energy), Wi-Fi Direct (formerly Peer-to-Peer Wi-Fi), a local area network (LAN), cellular, or the like. Such P2P synchronization may enable synchronization of data without reliance on a client-server or similar communications network. For example, where a military unit is screening individuals in a remote location that is isolated from the Internet or the like, mobile devices of the soldiers in the unit may synchronize with one another to share a latest received version of watchlist data for the purpose of threat screening and to share updated access control data entries, including additions or edits, for the purpose of logging characteristics and the current status of individuals.

In some embodiments, watchlist data, such as a BEWL or a portion thereof, is obtained from a third party source, such as a DoD server, by way of an external communications network and is disseminated to co-located peer devices by way of P2P synchronization, and access control data obtained by way of one or more peer devices is disseminated to co-located peer devices by way of P2P synchronization and is transmitted to a third party destination, such as an access control system server, by way of an external communications network. For example, watchlist data that includes some or all of a BEWL may be provided from a BEWL source (e.g., a DoD server) to a first mobile device (e.g., in the possession of a first soldier) of a group of peer mobile devices (e.g., that are in the possession of a first group of soldiers that includes the first soldier) by way of a client-server communications network, such as the Internet, and the watchlist may be provided from the first mobile device to some or all of the other peer mobile devices by way of a P2P synchronization operation, resulting in each of the of the mobile devices of the group of peer mobile devices having a local copy of the watchlist data stored thereon. In response to a soldier encountering an individual, the soldier may collect subject data that includes biometric data collected from the individual by way of a biometric sensor of the soldier's mobile device, including a fingerprint obtained by way of a fingerprint scanner of the soldier's mobile device, and biographic data collected for the individual, including a name, date of birth and status (e.g., boarded transport vehicle) for the individual, that is entered by the soldier via a user interface of the soldier's mobile device. Access control data, such as an access control entry, that includes the biometric and biographic data for the individual obtained and stored on the soldier's mobile device, may, in turn, be transmitted from the soldier's mobile device to some or all of co-located soldiers' mobile devices by way of a P2P synchronization operation, resulting in each of the of the co-located mobile devices of the group of peer mobile devices having a local copy of the subject data and other relevant access control data. Upon a mobile device having a local copy of a “new” access control data entry connecting to the Internet, the mobile device may conduct an access control data upload operation to transmit the “new” access control data entry to an access control system server, which may, in turn store the “new” access control data entry for use in future operations. In some embodiments, a peer device that generates an access control data entry is tasked with uploading that data to a destination. For example, in response to the soldier collecting “new” biometric and biographic data from the individual via the soldier's mobile device, the soldier's mobile device may generate a corresponding “new” access control data entry and conduct a peer synchronization operation to disseminate the “new” access control data entry to other co-located mobile devices associated with soldiers in the same unit. Upon the soldier's mobile device connecting to the Internet, for example, at a future time, the soldier's mobile device may conduct an access control data upload operation to send the “new” access control data entry to an access control server for use in updating associated access control data. Notably, in some embodiments, an access control server updates given access control data to reflect a most-recent version of the access control data. For example, where an entry for the same access control data is received as a first version from a first device and then as a second version from a second device, the access control server may store the second version as the current version of the given access control data based on it being deemed the most recent (e.g., based on a later timestamp, it being received later/last, or the like).

As described, certain embodiments can be employed in the context of biometric screening employed within a military context. Although certain embodiments are described in a given context for the purpose of illustration, embodiments may be employed in any suitable context. For example, certain embodiments may be employed for screening individuals to verify whether they are allowed access to a job, a facility, a resource, or the like. For example, such biometric screening may be accomplished in assessing individual candidates for jobs with an establishment, and upon determination that the individual is not a threat, the individual may be provided a job and enrolled into a monitoring system, with the biometric data for the individual obtained at enrollment used daily to verify the individual's identify and status as they report for work each day and are check-in using biometric scanning.

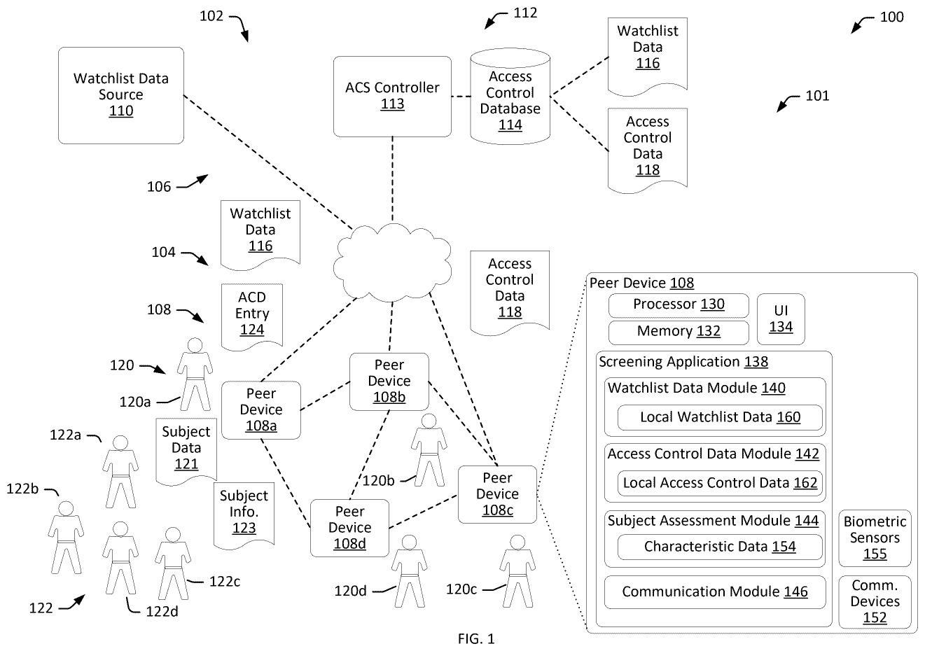

FIG. 1 is a diagram that illustrates a subject monitoring environment (or “environment”) 100 in accordance with one or more embodiments. In the illustrated embodiment, environment 100 includes a subject monitoring system (or “monitoring system”) 101 that includes various entities communicatively coupled by way of a communications network 102, which includes a peer-to-peer network (or “peer network” or “P2P network”) 104 and a device network 106 that are employed to facilitate communications between peer devices 108 (e.g., peer devices 108a-108d), a watchlist data source (or “watchlist source”) 110, and an access control system (or “ACS”) 112 that includes an access controller 113 and an access control database 114 operable to store watchlist data 116 and access control data 118.

As described, in some embodiments, monitoring system 101 is operable to maintain biometric information concerning individuals of interest, to enable operators 120 (e.g., operator 120a-120d) to use associated peer devices 108 (e.g., peer devices 108a-108d) to obtain subject data 121 for monitored subjects 122 (e.g., monitored subjects 122a-122d), where watchlist data 116 and access control data 118 are synchronized across peer devices 108 (e.g., synchronized across peer devices 108a-108d) and used by peer devices 108 to determine a threat level, status information, or the like concerning monitored subjects 122. This data can, in turn, be employed by operators 120 to determine how to interact with subjects 122, such as whether to allow one or more of the subjects 122 to gain access to a resource (e.g., to gain access to a facility, to gain access to transportation, to have an opportunity to work in a given position, or the like), to detain one or more of the subjects 122, or the like. For example, where each of operators 120 (e.g., each of operators 120a-120d) is a soldier and each of peer devices 108 (e.g., each of peer devices 108a-108d) is a mobile device (e.g., a smart phone type check-in device) associated with a respective operator 120 and having a fingerprint scanner and a check-in application installed thereon, a given soldier operator 120 may employ the fingerprint scanner of her/his peer device 108 to obtain a fingerprint of a monitored subject 122 (e.g., an individual/person). The check-in application may compare the fingerprint to watchlist data 116 stored on the peer device 108 to determine subject information 123, such as a threat level or other information concerning the subject 122, and the check-in application may present the subject information 123 for viewing by the operator 120. In such an embodiment, the operator 120 can, in turn, employ the subject information 123 to determine how to interact with the subject 122, such as to allow the subject 122 to gain access to a resource, to detain the subject 122, or the like.

In some embodiments, watchlist data 116 includes information concerning one or more individuals of interest. For example, watchlist data 116 may include information concerning entities or individuals that are subject to legal or regulatory scrutiny due to suspicions of involvement in illegal activities (e.g., terrorism), security threats, or violations of regulations or laws. This may be, for example, a compilation of individuals, entities, or items that are flagged for monitoring or potential restriction. In some embodiments, watchlist data 116 includes respective sets of data for characteristics associated with respective individuals of interest. For example, watchlist data 116 may include, for each individual of interest identified therein, a respective set of data for the individual, such one or more biometric characteristics of the individual (e.g., a fingerprint, a voiceprint, a facial print, a retinal print, or the like), one or more biographic characteristics of the individual (e.g., personal information such as name, alias, known affiliations, date of birth, government identification number, or the like), or other relevant information for the individual, such as a threat level (e.g., low, medium, high risk) for the individual, actions to be taken with the individual (e.g., detain, limit access, use caution, etc.), or the like. In some embodiments, watchlist data 116 includes data sourced from a watchlist, such as a biometrics-enabled watchlist (BEWL) (sometimes referred to as a “defense watchlist”). For example, watchlist data 116 may include some or all of a BEWL aimed at enhancing national security and protecting military assets and maintained by the U.S. Department of Defense (DoD) or a similar entity. As described, such a BEWL may be used to identify individuals with a history of criminal activity, terrorism ties, or other security concerns, which allows the DoD and other informed entities to mitigate potential risks and safeguard interests. For example, watchlist data 116 that includes, or is otherwise sourced from, a BEWL may be used to screen individuals seeking access to military installations, secure facilities, border entry, evacuation, transport, or the like.

In some embodiments, watchlist data 116 provided to a given P2P network 104 includes information that is of particular relevance to the P2P network 104 or may exclude certain information that is not of particular relevance to the P2P network 104. For example, where peer devices 108a-108d of peer-to-peer network 104 are employed to screen individuals in a given region, watchlist data 116 provided to one of peer devices 108a-108d by watchlist data source 110 may be limited to a listing of individuals of interest known to be located in or around the region and associated sets of data, and may not include a listing or data for individuals of interest known to not be in or around the region. For example, where a BEWL maintained by watchlist data source 110 includes a listing of individuals across the world that includes subsets of individuals in different regions, and where peer device 108a requests watchlist data 116 for a given one of those regions, watchlist data source 110 may provide the subset of watchlist data 116 that includes data concerning individuals in the given region. Such a filtering may improve performance, especially in the case of bandwidth limited networks and memory limited peer devices, by limiting the amount of watchlist data 116 provided to or processed by peer devices 108.

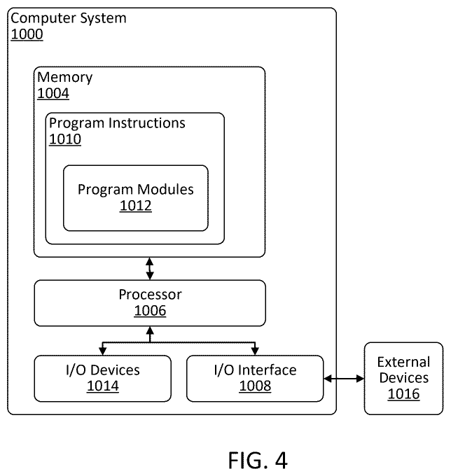

In some embodiments, watchlist data source 110 is an entity operable to maintain watchlist data 116 concerning individuals of interest, which may include, for example, a watchlist that includes respective sets of biometric characteristics associated with respective individuals of the individuals of interest. Continuing with the above example of a BEWL, watchlist data source 110 may be a server operated by an entity (e.g., the DoD) that maintains watchlist data 116 that includes a BEWL that includes, for each individual of a set of individuals of interest identified therein, a respective set of data for the individual, such as biometric characteristic of the individual (e.g., a fingerprint, a voiceprint, a facial print, a retinal print, or the like), biographic characteristics of the individual (e.g., personal information such as name, alias, known affiliations, date of birth, government identification number, or the like), or other relevant information for the individual, such as a threat level (e.g., low, medium, high risk) for the individual, actions to be taken with the individual (e.g., detain, limit access, use caution, or the like), or the like. Such a server may, for example, be operable to provide (or “serve”) respective sets of watchlist data 116 to one or more client devices, such as peer devices 108. As noted in the prior example, where peer devices 108a-108d of peer-to-peer network 104 are employed to screen individuals in a given region, watchlist data source 110 may operate to serve, to one or more of peer devices 108a-108d watchlist data 116 that includes a subset of a BEWL maintained by watchlist data source 110 that includes a listing of individuals of interest known to be in or around the given region and associated sets of data, such a biometric and biographic characteristics, or other relevant information, for each of the individuals of interest. In some embodiments, watchlist data source 110 includes a computer system, which may be the same or similar to computer system 1000 described with regard to at least FIG. 4.

In some embodiments, access control data 118 includes information concerning one or more individuals, which may include individuals interest. For example, access control data 118 may include subject data that includes information concerning individuals, including information concerning encounters with those individuals or information concerning individuals based on watchlist data 116 obtained from a watchlist data source 110. In some embodiments, when an individual is encountered, information regarding the individual and the encounter is collected and logged in an access control data entry (or “access control log entry”) 124 of access control data 118, which may include, for example, subject data, such as biometric and biographic characteristics, or other relevant information, for the individual and the encounter. Continuing with the above example, where a soldier operator 120a employs her/his mobile peer device 108a to obtain biometric data that includes fingerprint of subject 122a, to enter biographic data that includes the name and date of birth of subject 122a, and to enter other relevant information such as the location of the encounter and one or more persons co-located or otherwise affiliated with subject 122a, the peer device 108a may create and store (or “log”) a corresponding access control data entry 124, including the biometric, biographic and other relevant information collected for subject 122a. As described, in such an embodiment, peer device 108a may also share access control data 118 that includes the corresponding access control data entry 124 with co-located peer devices 108b-108d so that each of peer devices 108b-108d has access to the access control data entry 124. This, for example, may be accomplished by way of a P2P synchronization operation, resulting in each of peer devices 108b-108d having a local copy of the access control data entry 124 logged in memory 132 thereof. Further, peer device 108a may share access control data 118 that includes the corresponding access control data entry 124 with ACS 112 so that ACS 112 has access to the access control data entry 124. This, for example, may be accomplished by way of a transmission (e.g., an upload) from peer device 108a to ACS controller 113, which may, in turn, log the access control data entry 124 in access control data 118 maintained on access control database 114. Similar uploads of access control data entries 124 may be provided by multiple peer devices 108 for various subjects 122 and encounters, such that access control data 118 maintained by ACS 112 provides a thorough log of biometric, biographic, and other relevant information for subjects 122. As described, in some embodiments, an access control data entry 124 is uploaded by a peer device 108 that first creates the access control data entry 124. In some embodiments, ACS 112 may update given access control data 118 to reflect a most-recent version of the data. For example, where a first access control data entry 124 for subject 122a is received from peer device 108a and then a second access control data entry 124 for subject 122a is received from peer device 108b, ACS controller 113 may store the second access control data entry 124 from peer device 108a as the current version of the access control data entry 124 for subject 122a based on it being deemed the most recent (e.g., based on a later timestamp, it being received later/last, or the like).

In some embodiments, ACS 112 is an entity operable to maintain access control data 118, which may include, for example, information concerning individuals, such as information concerning encounters with those individuals or information concerning individuals based on watchlist data 116 obtained from a watchlist data source 110. Continuing with the above example, access control data 118 maintained by ACS 112 may be a thorough log of biometric, biographic, and other relevant information for subjects 122 built based on access control data entry 124 uploads provided by multiple peer devices 108 for various subjects 122 and associated encounters. For example, where soldier operator 120a employs mobile peer device 108a for screening two subjects 122 (e.g., including subject 122a) and generating two corresponding access control data entries 124, soldier operator 120b employs mobile peer device 108b for screening eight subjects 122 (e.g., including subject 122b) and generating eight corresponding access control data entries 124, soldier operator 120c employs mobile peer device 108c for screening six subjects 122 (e.g., including subject 122c) and generating six corresponding access control data entries 124, and soldier operator 120d employs mobile peer device 108d for screening four subjects 122 (e.g., including subject 122d) and generating four corresponding access control data entries 124, each of mobile peer devices 108a-108b may upload their corresponding sets of access control data entries 124 to access controller 113, which may, in turn, log the twenty access control data entries 124 in access control data 118 maintained on access control database 114. In some embodiments, ACS 112 includes a computer system, which may be the same or similar to computer system 1000 described with regard to at least FIG. 4. For example, ACS controller 113 may be a server-type computer system that is operable to service clients, such as peer devices 108.

In some embodiments, a peer device 108 is an electronic device that is operable to exchange data with other devices, including other peer devices 108 of P2P network 104. In some embodiments, a peer device 108 includes a computer system, which may be the same or similar to computer system 1000 described with regard to at least FIG. 4. For example, a peer device 108 may include a processor 130, a memory 132, a user interface 134, and various program modules and systems for carrying out associated functions. For example, memory 132 may store a screening application 138 that includes a watchlist data module 140, an access control data module 142, a subject assessment module 144, and a communications module 146, along with biometric sensors 155 and communication devices 152. In some embodiments, biometric sensors 155 include one or more biometric sensors operable to obtain biometric characteristics of an individual subject 122. For example, biometric sensors 155 may include some or all of a fingerprint scanner operable to obtain a fingerprint of an individual, a palm scanner operable to obtain a palmprint of an individual, a face scanner operable to obtain a facial scan/image/print of an individual, a retinal scanner operable to obtain a retinal scan/image/print of an individual, a voice scanner (e.g., a microphone) operable to obtain a voice scan/recording/print of an individual, or the like. Communication devices 152 may include devices that provide for wireless or wired transmission of data from peer device 108 to other devices, such as other peer devices 108, watchlist data source 110, ACS 112, or the like. For example, communication devices 152 may include hardware and software that provide for communication of data by way of Bluetooth (e.g., Bluetooth Low Energy), Wi-Fi Direct (or “Peer-to-Peer Wi-Fi”), a local area network (LAN), cellular, or the like communication protocols.

In some embodiments, watchlist data module 140 is operable to maintain local watchlist data 160. For example, as described, watchlist data module 140 may operate to obtain watchlist data 116 from a watchlist data source 110 or by way of a P2P synchronization with one or more other peer devices 108 and update local watchlist data 160 to reflect current versions of watchlist data 116.

In some embodiments, access control data module 142 is operable to maintain local access control data 162. For example, access control data module 142 may operate to obtain access control data 118 from access control system 112, obtain access control data 118 from one or more other peer devices 108 by way of a P2P synchronization, or generate access control data 118 based on characteristics sensed or entered by way of the associated peer device 108, and update local access control data 162 to reflect current versions of access control data 118. Local access control data 162 or access control data 118 may include a log of access control data entries 124 or similar information.

In some embodiments, subject assessment module 144 is operable to obtain, assess or generate characteristic data 154 for subjects 122. For example, subject assessment module 144 may obtain subject data 121 that includes biometric, biographic, or other relevant information for a subject 122. This may include, for example, obtaining biometric information concerning an subject 122a by way of one or more biometric sensors 155 (e.g., obtaining a fingerprint of subject 122a by way of a fingerprint scanner, obtaining a facial image of subject 122a by way of a face scanner, obtaining a retinal image of an eye of subject 122a by way of a retinal scanner, or obtaining a voice print of a voice of subject 122a by way of a voice scanner), obtaining biographic information concerning subject 122a (e.g., obtaining biographic information, such as name, date of birth, and the like for subject 122a by way of operator 120a entering the biographic information) via UI 134 of peer device 108), and obtaining other relevant information concerning subject 122a (e.g., by way of operator 120a entering the location of an encounter with subject 122a and names of one or more persons, such as subjects 122b, 122c and 122d, co-located or otherwise affiliated with subject 122a via UI 134 of peer device 108). In such an embodiment, subject assessment module 144 may generate characteristic data 154 that includes a corresponding access control data entry 124 corresponding to the collected subject data 121. For example, subject assessment module 144 may generate a corresponding access control data entry 124 that includes the biometric, biographic, and other relevant information collected for subject 122a that is stored in characteristic data 154. In such an embodiment, subject assessment module 144 may provide characteristic data 154, including the corresponding access control data entry 124, to access control data module 142, which may, in turn, update local access control data 162 to include or otherwise reflect the corresponding access control data entry 124 or other relevant portions of characteristic data 154. In some embodiments, a subject is provided with an identifying item (e.g., a badge, key card, QR code, barcode, fob, bracelet, or the like) that can be used to identify the subject, and subsequent biometric verification is based on identifying the subject using the item. For example, subject 122a may be enrolled by way of biometric scanning and a personal survey to acquire biometric and biographic information that is stored in association with an identifier of subject 122a. Subject 122a may be provided with an ID badge that includes a QR code that is associated with the identifier of subject 122a, and subject 122a may carry the badge with her/him and use the badge to initiate a check-in process. For example, upon reaching a work entry access point each morning, subject 122a may scan the QR code at a QR code reader at the access point and scan her/his fingerprint at a biometric scanner of the access point. In response, a threat check may be conducted that includes using the QR scan to identify subject 122a and comparing the scanned fingerprint against a fingerprint stored in association with the identifier of subject 122a to verify the identity and status of subject 122a. Upon verification, subject 122a may be provided entry through the access point.

In some embodiments, communications module 146 is operable to communicate data between peer device 108 and other devices, such as other peer devices 108, watchlist data source 110, ACS 112, or the like. For example, in a P2P synchronization operation, communications module 146 may employ one or more communication devices 152 to provide for transmission of watchlist data 116, access control data 118, access control data entries 124, or the like to or from one or more other peer devices 108. In a client-server-based communication operation, communications module 146 may employ one or more communication devices 152 to provide for transmission of watchlist data 116, access control data 118, access control data entries 124, or the like to a network server device, such as watchlist data source 110 or access controller (e.g., an access control server) 113.

In some embodiments, P2P network 104 is defined by multiple peer devices 108 that are communicatively coupled by way of communication between peer devices 108. A peer device 108 in P2P network 104 may be a computer, mobile device, or other networked device that operates on an equal footing with other peer devices 108 in P2P network 104, being capable of both requesting and delivering data, resources, or services directly to and from other peer devices 108 in P2P network 104 without the need for centralized servers acting as intermediaries to direct communications between peer devices 108. For example, peer device 108a may exchange (e.g., send or receive) data directly with other peer devices 108 that are in transmission range, such as peer devices 108a and 108b, by way of a suitable wireless protocol, such as a Peer-to-Peer Wi-Fi connection between the respective pairs of devices. Where a given peer device 108 is not within communication range of another peer device 108 with which data is to be exchanged, multi-hop P2P communication may be employed to relay data through one or more intermediate peer devices 108 to reach a destination peer device 108. For example, where peer device 108a is in communication range of peer device 108b and 108d, but is not in range of peer device 108c to which data is to be transferred from peer device 108a, data may be transmitted indirectly from source peer device 108a to intermediate peer device 108b, and from intermediate peer device 108b to destination peer device 108c. Peer devices 108 that are within range of one or more other peer devices 108, whether by way of direct or indirect (e.g., multi-hop) P2P communication, may be referred to as co-located peer devices 108. For example, peer devices 108a, 108b, 108c and 108d may be referred to as “co-located” devices based on the ability of the peer devices 108 to exchange data with one another via direct or indirect P2P communication. In some instances, a peer device 108 may move into or out of co-location with other peer devices 108. For example, if peer devices 108c and 108d move far enough away from peer devices 108a and 108b to lose communication with them, but peer devices 108a and 108b remain close enough to maintain direct communication therebetween, and peer devices 108c and 108d remain close enough to maintain direct communication therebetween, peer devices 108a and 108b may be a first set of co-located peer devices 108, and peer devices 108c and 108d may be a second, separate set of co-located peer devices 108. Thus, as peer devices 108 move from one location to another they may leave and join various sets (or “groups”) of co-located peer devices 108.

In some embodiments, co-located peer devices 108 synchronize data by way of P2P synchronization. For example, each of peer devices 108a-108d may constantly check for changes made to shared files or data by other peer devices 108a-108d and engage in direct or indirect transfer of data between peer devices 108 to synchronize any changes across all co-located peer devices 108 to ensure consistency and up-to-date information across peer devices 108a-108d. For example, where peer device 108a generates an access control entry 124 based on an encounter with subject 122a by operator 120a, peer device 108a may disseminate a copy of the access control entry 124 to peer devices 108b and 108d by way of direct P2P communication and to peer device 108c by way of indirect P2P communication (e.g., a multi-hop through intermediary peer device 108b or 108d). In some embodiments, a P2P synchronization service is employed to provide P2P synchronization of data between peer devices 108. For example, P2P synchronization of data between peer devices 108a, 108b, 108c and 108d may be accomplished using a synchronization service such as Edge Sync Platform provided by Ditto, having headquarters in San Francisco, California.

In some embodiments, device network 106 is a client-server-based network that includes server network devices, such as watchlist data source 110 and ACS 112, that service requests from client network devices, such as peer devices 108 or other network devices, by way of the Internet or a similar network. For example, watchlist data source 110 may include a network server that is operable to provide watchlist data 116 to a requesting peer device 108 by way of the Internet. In some embodiments, a peer device 108 may obtain watchlist data 116 from another peer device 108 or other source. ACS controller 113 may be a network server that is operable to provide watchlist data 116 or access control data 118 (e.g., retrieved from access control database 114) to a requesting peer device 108, or to receive watchlist data 116 or access control data 118 from a peer device 108 (and update access control database 114 to reflect the data received). In some embodiments, peer devices 108 are operable to communicate by way of one or both of P2P network 104 and device network 106. For example, peer device 108a may obtain watchlist data 116 from a server of watchlist data source 110 by way of device network 106 (e.g., by way of the Internet), and peer device 108a may, in turn, transmit a copy of watchlist data 116 to each of peer devices 108b-108d by way of peer network 104 (e.g., by way of P2P synchronization), and one or more of peer devices 108a-108d may, in turn, transmit a copy of watchlist data 116 to ACS controller 113 by way of device network 106 (e.g., by way of the Internet). In the context of P2P synchronization involving the upload/download of data between a server and one or more peer devices 108 of a peer group by way of a client-server-based network, and synchronization of the data across the peer devices 108 by way of P2P synchronization, the server device (e.g., watchlist data source 110 or ACS controller 113) may be referred to as a “big peer” and the peer devices 108 (e.g., each of peer devices 108a-108d) may be referred to as “small peers.”

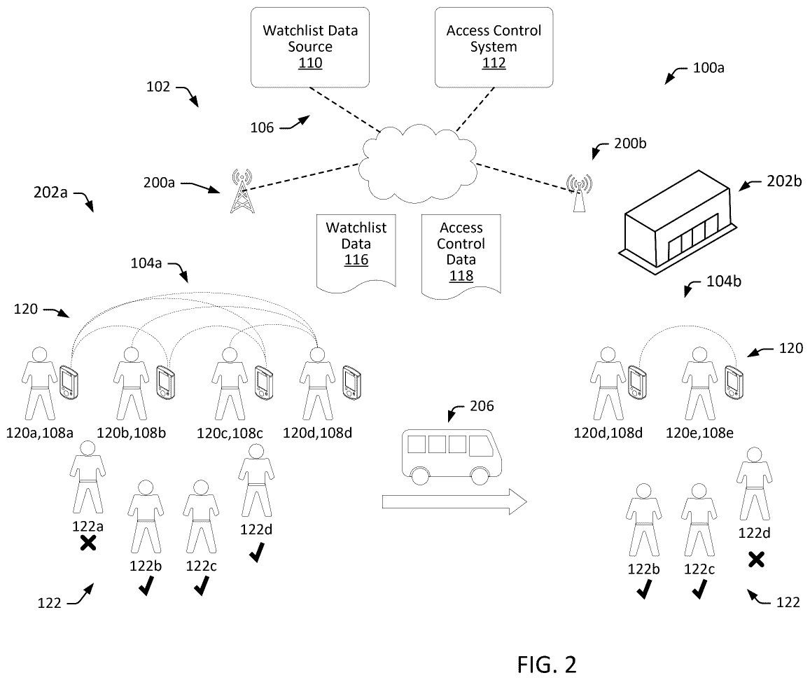

FIG. 2 is a diagram that illustrates an example subject monitoring environment 100a in accordance with one or more embodiments. The illustrated environment 100a may, for example, provide for transportation of subjects 120 between locations in accordance with one or more embodiments. In the illustrated embodiment, a communication network 102 includes a device communication network 106 that includes watchlist data source 110, access control system 112, a first wireless access point 200a located proximate a first location (e.g., a field) 202a, and a second wireless access point 200b located proximate a second location (e.g., housing facility) 202b. Communication network 102 includes an initial/first P2P communication network 104a that includes peer devices 108a-108e associated with respective soldier operators 120a-120e, and a developed/second P2P communication network 104b that includes peer devices 108d and 108e associated with respective soldier operators 120d and 120e. As described, embodiments may be employed to effectuate the safe and effective check-in, detention, transfer, and housing of subjects 122, including subjects 122a-122d.

For example, subjects 122a-122d may be individuals identified as candidates for transfer from field 202a to housing facility 202b by way of a transport vehicle 206 (e.g., a bus, airplane, train, ship, or the like). Prior to soldier operators 120a-120c encountering subjects 122a-122d at field 202a, soldier monitor 120a and her/his associated peer device 108a may move into communication range of first access point 200a (e.g., a cellular tower) that provides Internet access. In response to peer device 108a connecting to the Internet via first access point 200a, a communication module 146 of peer device 108a may alert the other modules, and a watchlist data module 140 of a screening application running on peer device 108a may, in response, send to a server of watchlist data source 110, a request for a current watchlist for a region that includes field 202a and housing facility 202b. In response to receiving the request for the current watchlist, the server of watchlist data source 110 may, in turn, send corresponding watchlist data 116 that includes a listing of individuals that are considered be known threats in the region, and associated sets of characteristic data, such as biometrics (e.g., fingerprints), biographic (e.g., names), or other relevant information (e.g., threat level, actions to be taken, and so forth) for each, with the listing individuals including a listing for subject 122a that includes corresponding fingerprint data, name (“John Smith”), threat level (“high”), and a recommended action (“detain on site”). In response to receiving requested watchlist data 116, a watchlist data module 140 of the screening application may update local watchlist data 160 stored in a memory of peer device 108a to include the listing of individuals of watchlist data 116, including the listing for subject 122a (John Smith). As soldier monitor 120b moves away from access point 200a to meet soldier monitors 120b and 120c located at a check-in location of field 202a that is out of communication range of access point 200a, soldier monitor 120b and her/his associated peer device 108b may move into Peer-to-Peer Wi-Fi (or other protocol, such Bluetooth) communication range of peer device 108a, with soldier monitor 120c and his/her associated peer device 108c in Peer-to-Peer Wi-Fi communication range of peer device 108b (but out of range of peer device 108a). In response to detecting co-location of peer devices 108a, 108b and 108c, the watchlist data module 140 screening application 138 of one, some or each of co-located peer devices 108a, 108b and 108c may engage in a P2P synchronization operation that includes a direct communication of watchlist data 116 (including the listing of individuals of watchlist data 116, including the listing for subject 122a (John Smith)) from peer device 108a to peer device 108b, and an indirect communication of watchlist data 116 (including the listing of individuals of watchlist data 116, including the listing for subject 122a (John Smith)) from peer device 108a to peer device 108c, by way of a multi-hop communication in which peer device 108b serves as an intermediary. Upon soldier monitor 120d arriving at the remote location and her/his associated peer device 108d subsequently coming into Peer-to-Peer Wi-Fi communication range of peer device 108b (e.g., as all soldier monitors 120a-120b meet up at the check-in location, prior to conducting screening and check-in of subjects 122a-122d), in response to detecting co-location of peer devices 108b and 108d, the watchlist data module 140 screening application of one or both of co-located peer devices 108b and 108d may engage in a P2P synchronization operation that includes a direct communication of watchlist data 116 (including the listing of individuals of watchlist data 116, including the listing for subject 122a (John Smith)) from peer device 108b to peer device 108d. As a result of the synchronization, the watchlist data modules 140 of the screening applications 138 of peer devices 108b-108d may update respective sets of local watchlist data 160 stored in a memory of each respective peer device 108b, 108c and 108d to include the listing of individuals of watchlist data 116, including the listing for subject 122a (John Smith).

As the check-in screening process begins, soldier monitor 120a may encounter subject 122a and employ the screening application of peer device 108a to obtain subject data 121 for subject 122a that includes a fingerprint (e.g., obtained by way of a fingerprint scanner type biometric sensor 155 of peer device 108a), enter a name (Steve Smith) and date of birth (Jan. 8, 2000) provided by subject 122a, and enter a date and location of the encounter (Apr. 1, 2024—field) (e.g., by way of the UI 134 of peer device 108a). In response to obtaining the subject data 121 for subject 122a, a subject assessment module 144 of the screening application 138 of peer device 108a may compare the subject data 121 for subject 122a to information contained in local watchlist data 160 of peer device 108a. In this case, the subject assessment module 144 of the screening application may identify a match between the fingerprint obtained for subject 122a and a fingerprint associated with the listing for subject 122a (John Smith) stored in local watchlist data 160. In response to determining the match, the subject assessment module 144 of the screening application 138 of peer device 108a may cause the subject assessment module 144 of the screening application 138 to display, via the user interface 134 of peer device 108a, a message that states: “Current subject is named John Smith, has a high threat level, and a recommended action of detain.” In response to receiving the message, soldier monitor 120a may prevent subject 122a from boarding transport vehicle 206, detain subject 122a in field 202a, and submit, via the UI 134 of peer device 108a, a status entry that subject 122a (John Smith) has been detained in field 202a. In response to the status entry, an access control data module 142 of the screening application of peer device 108a may, in turn, generate an access control data entry 124 for subject 122a, which may include, for example, biometric and biographic characteristics, or other relevant information, for subject 122a, such as the fingerprint obtained, the name/alias given (Steve Smith) used, the date of birth given (Jan. 8, 2000), the date and location of the encounter (Apr. 1, 2024—field), and a status (detained in field). With soldier monitor 120a and peer device 108a being near and co-located with soldier monitors 120b-120d and mobile peer devices 108b-108d, in response to detecting co-location of peer devices 108a-108d, the access control data modules 142 of the screening applications 138 of the co-located peer devices 108a-108d may engage in a P2P synchronization operation that includes communication of access control data entry 124 for subject 122a. As a result of the synchronization, the access control data modules 142 of the screening applications 138 may update respective sets of local access control data 162 stored in a memory 132 of each of respective peer devices 108b, 108c and 108d to include the access control data entry 124 for subject 122a. When soldier monitor 120a and peer device 108a later move into range of first access point 200a (e.g., after the subject check-in is complete), the access control data module 142 of the screening application 138 of peer device 108a may initiate an upload of the “new” access control data entry 124 for subject 122a to a server of access control system 112 (e.g., ACS controller 113), which may, in turn, update access control data 118 stored on access control database 114 to include or otherwise reflect the access control data entry 124 for subject 122a.

As the check-in screening process continues, soldier monitors 120b, 120c and 120d may encounter respective ones of subjects 122b, 122c and 122d and employ the respective screening applications of peer device 108b, 108c and 108d to obtain respective sets of subject data 121 for subjects 122b, 122c and 122d that include respective fingerprints (e.g., obtained by way of a fingerprint scanner type biometric sensor 155 of peer devices 108b, 108c and 108d) and enter respective names (John Doe, Jane Smith, and Mike James) and dates of birth (Nov. 8, 2000, Dec. 1, 1999 and Jun. 4, 1980) provided by respective subjects 122b, 122c and 122d, and enter the date and location for the encounters (Apr. 1, 2024—field) (e.g., by way of the respective UIs 134 of peer devices 108b-108d). In response to obtaining the subject data for subjects 122b, 122c and 122d, respective subject assessment modules 144 of the screening applications 138 of peer device 108b, 108c and 108d may compare the respective sets of subject data for subjects 122b, 122c and 122d to information contained in respective local watchlist data 160 of peer devices 108b, 108c and 108d. In this case, the subject assessment modules 144 of the screening applications 138 may not identify a match between the fingerprints for subjects 122b, 122c and 122d, and the fingerprints, names or the like associated with the listings stored in the respective sets of local watchlist data 160. In response to determining that no match exists, the respective subject assessment modules 144 of the screening applications of peer devices 108b, 108c and 108d may cause the respective subject assessment modules 144 of the screening applications to display, via the user interfaces 134 of peer devices 108b, 108c and 108d, a message that states: “Current subject is not a threat match.” In response to receiving the messages, soldier monitors 120b, 120c and 120d may allow respective subjects 122b, 122c and 122d to board transport vehicle 206 and submit respective status entries (e.g., by way of the respective UIs 134 of peer devices 108b-108d) that subject 122b (John Doe), subject 122c (Jane Smith), and subject 122c (Mike James) have each boarded transport vehicle 206 bound for housing facility 202b. In response to the status entry, an access control data module 142 of the respective screening applications 138 of peer devices 108b, 108c and 108d may, in turn, generate respective access control entries 124 for subjects 122b, 122b, and 122c, which may include, for example, biometric and biographic characteristics, or other relevant information, for each of subjects 122b, 122b, and 122c, such as the fingerprints obtained, the names given (John Doe, Jane Smith, and Mike James), the dates of birth given (Nov. 8, 2000, Dec. 1, 1999 and Jun. 4, 1980), the date and location of the encounter (Apr. 1, 2024—field), and a status (boarded transport vehicle bound for housing facility). With soldier monitors 120a, 120b, 120c and 120d and peer devices 108a, 108b, 108c and 108d being near and co-located, in response to detecting co-location of peer devices 108a-108d, the respective access control data modules 142 of the screening applications 138 of the co-located peer devices 108a-108d may engage in a P2P synchronization operation that includes communication of the access control data entries 124 for subjects 122b, 122c and 122d. As a result of the synchronization, the access control data modules 142 of the screening applications 138 may update respective sets of local access control data 162 stored in a memory of each respective peer device 108a, 108b, 108c and 108d to include the access control entries 124 for subjects 122b, 122c and 122d.

In the illustrated embodiment, soldier monitor 120d may board transport vehicle 206 and accompany subjects 122b, 122c and 122d to housing facility 202b, where a subsequent screening and deboarding is conducted. Soldier monitors 120b and 120c may remain at field 202a, and when soldier monitor 120b and 120c and respective peer devices 108b and 108c later move into range of first access point 200a (e.g., after the subject check-in is complete), the respective access control data module 142 of the respective screening applications 138 of peer devices 108b and 108c may initiate an upload of respective ones of the “new” access control data entries 124 for subjects 122b and 122c (generated on the respective peer device 108b or 108c) to a server of access control system 112 (e.g., ACS controller 113), which may, in turn, update access control data 118 stored on access control database 114 to include or otherwise reflect the access control entries 124 for subjects 122b and 122c. A similar upload may occur when peer devices 108a and 108d later move into range of access point 200a or 200b.

As depicted, transport vehicle 206 may transport subjects 122b, 122c and 122d and soldier monitor 120d to housing facility 202b, where a subsequent screening and deboarding process is conducted. During travel of transport vehicle 206 from field 202a to housing facility 202b, watchlist data source 110 may, for example, determine that Mike James (subject 122d) is a threat and may update its watchlist to include a corresponding listing for Mike James (subject 122d) with a corresponding fingerprint, name (“Mike James”), threat level (“moderate”), and a recommended action (“keep under observation”).

Prior to arrival of transport vehicle 206 at housing facility 202b, soldier monitor 120e and her/his associated peer device 108e may move into communication range of second access point 200b (e.g., a Wi-Fi access point) that provides Internet access. In response to peer device 108e connecting to the Internet via second access point 200b, a watchlist data module 140 of a screening application 138 running on peer device 108e may send to a server of watchlist data source 110, a request for a current watchlist for a region that includes field 202a and housing facility 202b. In response to receiving the request for the current watchlist, the server of watchlist data source 110 may, in turn, send corresponding watchlist data 116 that includes a listing of individuals that are considered be known threats in the region, and associated sets of characteristic data, such as biometrics (e.g., fingerprints), biographics (e.g., names), or other relevant information (e.g., threat level, actions to be taken, and so forth) for each, with the listing of individuals including a listing for subject 122a that includes corresponding fingerprint data, a name (“John Smith”), threat level (“high”) and a recommended action (“detain on site”), and a listing for subject 122d that includes name (“Mike James”), threat level (“moderate”) and a recommended action (“keep under surveillance”). In response to receiving the requested watchlist data 116, a watchlist data module 140 of the screening application 138 running on peer device 108e may update local watchlist data 160 stored in a memory 132 of peer device 108e to include the listing of individuals of watchlist data 116, including the listing for subject 122a (John Smith) and the listing for subject 122d (Mike James).

Upon arrival of transport vehicle 206 at housing facility 202b, before the screening and deboarding process is conducted, soldier monitor 120e may move away from access point 200b to transport vehicle 206 at an arrival location of housing facility 202b that is out of communication range of access point 200b and arriving soldier monitor 120d and her/his associated peer device 108d may come into Peer-to-Peer Wi-Fi communication range of peer device 108e. In response to detecting co-location of peer devices 108d and 108e, the watchlist data module 140 of the screening application 138 of one or both of co-located peer devices 108d and 108e may engage in a P2P synchronization operation that includes a direct communication of watchlist data 116 (including the listing of individuals of watchlist data 116, including the “new” listing for subject 122d (Mike James), which is not already present in the local watchlist data 160 of peer device 108d) from peer device 108e to peer device 108d.

As the screening and deboarding process begins, soldier monitor 120d may encounter subject 122d and employ the screening application of peer device 108d to obtain subject data 121 for subject 122d that includes a fingerprint (e.g., obtained by way of a fingerprint scanner type biometric sensor of peer device 108d) and enter a name (Mike James) and date of birth (Jun. 4, 1980) provided by subject 122d, and enter a date and location of the encounter (Apr. 1, 2024—housing facility). In response to obtaining the subject data 121 for subject 122d, a subject assessment module 144 of the screening application 138 of peer device 108d may compare the current subject data 121 for subject 122d to information contained in a current version of the local watchlist data 160 of peer device 108d. In this case, the subject assessment module 144 of the screening application 138 may identify a match between the fingerprint for subject 122d and the fingerprint associated with the listing for subject 122a (Mike James) stored in local watchlist data 160 or a match between the name for subject 122d and the name (Mike James) associated with the listing stored in local watchlist data 160. In response to determining the match (of one or both of the fingerprint or name), the subject assessment module 144 of the screening application 138 of peer device 108d may cause the subject assessment module 144 of the screening application to display, via the user interface 134 of peer device 108d, a message that states: “Current subject is named Mike James, has a moderate threat level, and a recommended action of keep under surveillance.” In response to receiving the message, soldier monitor 120d may route subject 122d from transport vehicle 206 to a portion of housing facility 202b that is under surveillance and submit (e.g., by way of a UI 134 of peer device 108d) a status entry that subject 122d (Mike James) is housed and under surveillance at housing facility 202b. In response to the status entry, an access control data module 142 of the screening application 138 of peer device 108d may, in turn, generate an access control data entry 124 for subject 122d, which may include, for example, biometric and biographic characteristics, or other relevant information, for subject 122d, such as the most recent fingerprint obtained, the name (Mike James) used, the date of birth given (Jun. 4, 1980), the date and location of the encounter (Apr. 1, 2024—housing facility), and a status (housed and under surveillance at housing facility). With soldier monitor 120d and peer device 108d being near and co-located with soldier monitor 120e and mobile peer device 108e, in response to detecting co-location of peer devices 108d and 108e, the access control data modules 142 of one or both of the respective screening applications 138 of the co-located peer devices 108d and 108e may engage in a P2P synchronization operation that includes communication of the most recent access control data entry 124 for subject 122d (Mike James). As a result of the synchronization, the access control data modules 142 of the screening applications 138 may update respective sets of local access control data 162 stored in a memory of each respective peer device 108d and 108e to include the most recent access control data entry 124 for subject 122d (Mike James). When soldier monitor 120d and peer device 108d later move into range of second access point 200b (e.g., after the screening and deboarding process is complete), the access control data module 142 of the screening application 138 of peer device 108d may initiate an upload of the “new” access control entry 124 for subject 122d to a server of access control system 112 (e.g., ACS controller 113), which may, in turn, update access control data 118 stored on access control database 114 to include or otherwise reflect the new access control data entry 124 for subject 122d. In some embodiments, the update access control data 118 maintained by access control system 112 may be disseminated to other peer devices 108 to keep them updated. For example, following the update of access control data 118 stored on access control database 114 to include or otherwise reflect the new access control entry 124 for subject 122d, monitor 120a and her/his associated peer device 108a may move into communication range of first access point 200a (e.g., a cellular tower) that provides Internet access. In response to peer device 108a connecting to the Internet via first access point 200a, the access control data module 140 of the screening application 138 running on peer device 108a may send to ACS controller 113, a request for a current access control data 118 for the region including field 202a and housing facility 202b. In response to receiving the request for the current access control data, ACS controller 113 may, in turn, send corresponding access control data 118 that reflect the new access control entry 124 for subject 122d.

As the screening and deboarding process continues, soldier monitor 120e may encounter subjects 122b and 122c and employ a screening application of peer device 108e to obtain respective sets of subject data 121 for subjects 122b and 122c that include respective fingerprints (e.g., obtained by way of a fingerprint scanner type biometric sensor 155 of peer device 108e) and enter respective names (John Doe and Jane Smith) and dates of birth (Nov. 8, 2000 and Dec. 1, 1999) provided by respective subjects 122b and 122c, and enter the date and location for the encounters (Apr. 1, 2024—housing facility) (e.g., by way of the UI 134 of peer device 108e). In response to obtaining the subject data 121 for subjects 122b and 122c, the subject assessment module 144 of the screening application of peer device 108e may compare the respective sets of subject data 121 for subjects 122b and 122c to information contained in current local watchlist data 160 of peer device 108e. In this case, the subject assessment module 144 of the screening application 138 may not identify a match between the fingerprints for subjects 122b and 122c, and the fingerprints, names or the like associated with the listings stored in the respective sets of current local watchlist data 160. In response to determining that no match exists, the subject assessment module 144 of the screening application of peer device 108e may cause the subject assessment module 144 of the screening application 138 to display, via the user interface 134 of peer device 108e, a message that states: “Current subject is not a threat match.” In response to receiving the messages, soldier monitor 120e may escort respective subjects 122b, 122c and 122d into a non-surveillance portion of housing facility 202b and submit (e.g., by way of the UI 134 of peer device 108e) respective status entries that subject 122b (John Doe) and subject 122c (Jane Smith) are each housed in a non-surveillance portion of housing facility 202b. In response to the status entry, an access control data module 142 of one the screening application of peer device 108e may, in turn, generate respective access control entries 124 for subjects 122b and 122c, which may include, for example, biometric and biographic characteristics, or other relevant information, for each of subjects 122b and 122c, such as the fingerprints obtained, the names given (John Doe and Jane Smith), the dates of birth given (Nov. 8, 2000 and Dec. 1, 1999), the date and location of the encounter (Apr. 1, 2024—housing facility), and a status (housed in non-surveillance portion of housing facility). With soldier monitors 120d and 120e and peer devices 108d and 108e being near and co-located, in response to detecting co-location of peer devices 108d and 108e, one or both of the respective access control data modules 142 of the screening applications 138 of the co-located peer devices 108d and 108e may engage in a P2P synchronization operation that includes communication of the most recent access control entries 124 for subjects 122b and 122c. As a result of the synchronization, the access control data modules 142 of the screening applications 138 may update respective sets of local access control data 162 stored in the memory 132 of each respective peer device 108d and 108e to include the most recent access control entries 124 for subjects 122b and 122c.

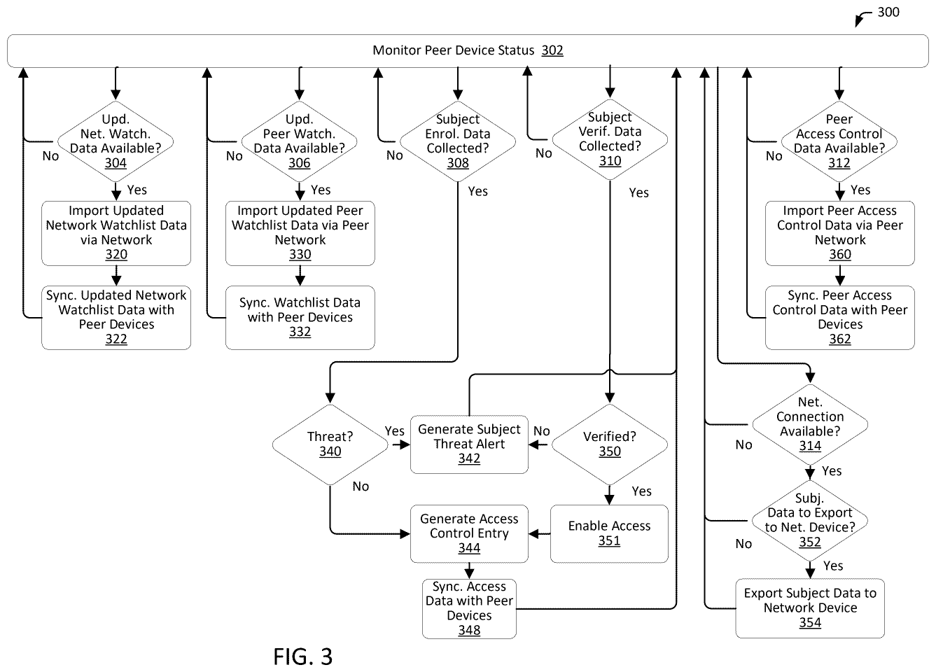

FIG. 3 is a flowchart diagram that illustrates a method 300 of monitoring and verifying the status of persons in accordance with one or more embodiments. Some or all of the procedural elements of method 300 may be performed, for example, by one or more entities of monitoring system 101 or another entity. For example, some or all the operations of method 300 may be performed by a peer device 108.

In the illustrated embodiment, method 300 includes monitoring peer device status (block 302). This may include monitoring to determine whether updated network watchlist data is available (block 304), to determine whether updated peer watchlist data is available (block 306), to determine whether subject enrollment data has been collected (block 308), to determine whether subject verification data has been collected (block 310), to determine whether peer access control data is available (block 312), or to determine whether a network connection is available (block 314).

In some embodiments, determining whether updated network watchlist data is available (block 304) includes querying a watchlist data source for a current set of watchlist data. For example, determining whether updated watchlist data is available may include a watchlist data module 140 of a peer device 108 querying watchlist data source 110 for an updated set of watchlist data for a given context (e.g., for a listing of individuals of interest for a given region). Referencing FIG. 2, this may include, for example, where peer device 108a last received an updated watchlist at 8:00 a.m. on Apr. 1, 2024, in response to communication module 146 providing an indication that peer device 108a is connected to communications network 102, watchlist data module 140 of peer device 108a querying watchlist data source 110 for any updates to the set of watchlist data 116 for the region including field 202a and housing facility 202b, since 8:00 a.m. on Apr. 1, 2024.

In response to an indication that no updated network watchlist data is available (block 304—no), method 300 may include returning to monitoring peer device status (block 302). For example, in response to watchlist data module 140 of peer device 108a receiving from watchlist data source 110, in response to a query for updates to the set of watchlist data 116, an indication that no updated (or “new”) network watchlist data 116 is available, the method returning to monitoring peer device status (block 302). In some embodiments, determining whether updated network watchlist data is available is conducted periodically to maintain local watchlist data 160 with a current listing of watchlist data 116. For example, in response to being connected to communications network 102 (e.g., in response to being connected to the Internet), watchlist data module 140 of peer device 108a may periodically (e.g., every 1 minute (min), 5 minutes (mins), 10 mins, 30 mins, 1 hour (hr.), 12 hours (hrs.), daily, weekly, monthly or the like) submit, to watchlist data source 110, a query for updates to the set of watchlist data 116.

In response to an indication that updated network watchlist data is available (block 304—yes), method 300 may proceed to importing updated network watchlist data via a network (block 320). For example, in response to watchlist data module 140 of peer device 108a receiving from watchlist data source 110, in response to a query for updates to the set of watchlist data 116, an indication that updated (or “new”) network watchlist data 116 is available, watchlist data module 140 of peer device 108a may proceed to download, from watchlist data source 110 via device network 106 of communications network 102, updated network watchlist data 116. Referencing FIG. 2, this may include, for example, where peer device 108a last received an updated watchlist at 8:00 a.m. on Apr. 1, 2024, watchlist data module 140 of peer device 108a downloading from watchlist data source 110 via access point 200a of device network 106, watchlist data 116 that includes updates to the watchlist for the region including field 202a and housing facility 202b since 8:00 a.m. on Apr. 1, 2024 and updating local watchlist data 160 stored in a memory of peer device 108a to reflect to reflect the updates to the watchlist included in the watchlist data 116.

In some embodiments, method 300 includes synchronizing watchlist data with peer devices (block 322). This may include, in response to downloading updated network watchlist data 116, conducting a peer-to-peer synchronization to synchronize the updated network watchlist data 116 across other co-located peer devices 108. Referencing FIG. 2, this may include, for example, in response to watchlist data module 140 of peer device 108a downloading updated from watchlist data source 110, watchlist data 116 that includes the listing for subject 122a (John Smith), conducting a P2P synchronization operation across peer network 104a to disseminate updated watchlist data 116 that includes the listing for subject 122a (John Smith) to each of other peer devices 108b-108d, so they, in turn, update their local watchlist data 160 to reflect the updated watchlist data 116 that includes the listing for subject 122a (John Smith). Such a sequence may provide for download and P2P synchronizing of updated watchlist data. Method 300 may include, upon completion of synchronizing watchlist data with peer devices (block 322), returning to monitoring peer device status (block 302).

In some embodiments, determining whether updated peer watchlist data is available (block 306) includes communicating with a peer to determine whether the peer (or another peer) has an updated watchlist to be synchronized. For example, determining whether updated watchlist data is available may include a watchlist data module 140 of a peer device 108 querying another peer device for an updated set of watchlist data 116. Referencing FIG. 2, this may include, for example, where peer device 108a last received an updated watchlist at 8:00 a.m. on Apr. 1, 2024, in response to communication module 146 of peer device 108a providing an indication that peer device 108a is connected to peer device 108b, watchlist data module 140 of peer device 108a querying watchlist data module 140 of peer device 108b for any updates to the set of watchlist data 116 (e.g., for the region including field 202a and housing facility 202b) since 8:00 a.m. on Apr. 1, 2024.

In response to an indication that no updated peer watchlist data is available (block 306—no), method 300 may include returning to monitoring peer device status (block 302). For example, in response to watchlist data module 140 of peer device 108a receiving from watchlist data module 140 of peer device 108b in response to a query for updates to the set of watchlist data 116, an indication that no updated (or no “new”) peer watchlist data 116 is available, the method may include returning to monitoring peer device status (block 302). In some embodiments, determining whether updated peer watchlist data is available is conducted periodically to maintain local watchlist data 160 with a current listing of watchlist data 116. For example, in response to being connected to one or more peer devices 108, watchlist data module 140 of peer device 108a may periodically (e.g., every 0.1 seconds, 0.5 seconds, 1 second, 5 seconds, 10 seconds, 30 seconds, 1 minute, or the like) submit, to a directly connected peer device 108, a query for updates to its set of watchlist data 116.

In response to an indication that updated peer watchlist data is available (block 306—yes), method 300 may proceed to importing updated peer watchlist data via a network (block 330). For example, in response to watchlist data module 140 of peer device 108a receiving from watchlist data module 140 of peer device 108b in response to a query for updates to the set of watchlist data 116, an indication that updated (or “new”) peer watchlist data 116 is available, data module 140 of peer device 108a may proceed to obtain, from watchlist data module 140 of peer device 108b via P2P network 104 (e.g., via a direct Peer-to-Peer Wi-Fi connection between peer devices 108a and 108b), updated peer watchlist data 116. Referencing FIG. 2, this may include, for example, where peer device 108a last received an updated watchlist at 8:00 a.m. on Apr. 1, 2024, watchlist data module 140 of peer device 108a receiving, from watchlist data module 140 of peer device 108a, watchlist data 116 that includes updates (e.g., for the region including field 202a and housing facility 202b) that occurred after 8:00 a.m. on Apr. 1, 2024 and updating local watchlist data 160 stored in the memory 132 of peer device 108a to reflect the updates to the watchlist data 116.

In some embodiments, method 300 includes synchronizing watchlist data with peer devices (block 332). This may include, in response to obtaining updated peer watchlist data 116, conducting a peer-to-peer synchronization to synchronize the updated peer watchlist data 116 across other co-located peer devices 108. Referencing FIG. 2, this may include, for example, in response to watchlist data module 140 of peer device 108a receiving from watchlist data module 140 of peer device 108b, updated watchlist data 116 that includes the listing for subject 122d (Mike James), conducting a P2P synchronization operation to disseminate updated watchlist data 116 that includes the listing for subject 122a (Mike James) to each of other peer devices 108b-108d, where they, in turn, update their local watchlist data 160 to reflect the updated watchlist data 116 that includes the listing for subject 122d (Mike James). Such a sequence may provide for P2P synchronizing of updated watchlist data. Method 300 may include, upon completion of synching watchlist data with peer devices (block 332), returning to monitoring peer device status (block 302).

In some embodiments, determining whether subject enrollment data has been collected (block 308) includes determining whether subject enrollment data has been obtained, such as biometric data, biographic data, or other relevant data for use in enrolling an individual for monitoring. For example, determining whether subject enrollment data has been collected may include a subject assessment module 144 of a peer device 108 determining whether biometric data, biographic data, or other relevant data for use in enrolling an individual has been received by way of a biometric sensor 155, user interface 134, or the like. Referencing FIG. 2, this may include, for example, where peer device 108a is present with soldier operator 120a that is active in enrolling newly encountered subject 122a, soldier operator 120 selecting to initiate an enrollment operation of a screening application 138 running on peer device 108a. In response to initiation of the enrollment operation, subject assessment module 144 may initiate a biometric scan operation that includes requesting that soldier operator 120a acquire a fingerprint scan of the candidate subject by way of the onboard fingerprint scanner, enter biographic information for the candidate subject, and enter any other relevant information for the candidate subject. Soldier operator 120a may, in turn, acquire subject data 121, including a fingerprint scan of subject 122a using the onboard fingerprint scanner type biometric sensor 155 of peer device 108a, enter a name (“John Smith”) provided by subject 122a by way of UI 134, and enter notes regarding subject 122a (e.g., such as an apparent affiliation with a group of persons) by way of UI 134. In response to determining that subject enrollment data has not been collected (e.g., no initiation of an enrollment operation) (block 308—no), method 300 may include returning to monitoring peer device status (block 302).

In response to the selection to initiate the enrollment operation and acquisition of corresponding subject data 121, subject assessment module 144 may determine that subject enrollment data has been collected (block 308—yes) and proceed to determining whether a threat exists (block 340). This may include comparing relevant parts of the subject data 121, such as collected biometrics of subjects 122, to corresponding watchlist data 116. For example, determining whether a threat exists may include comparing biometric data, such as a fingerprint, for a subject 122 to biometric data contained in watchlist data 116, such as fingerprints associated with individuals identified in the watchlist data 116, to determine whether a subject 122 is considered a threat. Referencing FIG. 2, this may include, for example, where peer device 108a is being used to enroll individual subject 122a and has collected a fingerprint scan of subject 122a using the onboard fingerprint scanner of peer device 108a, subject assessment module 144 may comparing the collected fingerprint to fingerprints of watchlist data 116 contained in local watchlist data 160, determining that the collected fingerprint matches a fingerprint in local watchlist data 160 that is associated with “John Smith,” and, in response, determining that a threat exists. As another example, this may include, where peer device 108b is being used to enroll subject 122b and has collected a fingerprint scan of subject 122b using the onboard fingerprint scanner of peer device 108b, the subject assessment module 144 comparing the collected fingerprint to fingerprints contained in watchlist data 116 of local watchlist data 160, determining that the collected fingerprint does not match a fingerprint in local watchlist data 160, and, in response, determining that a threat does not exist.

In response to determining that a threat exists (block 340—yes), method 300 may proceed to generating a subject threat alert (block 342). Generating a subject threat alert (block 342) may include providing an alert that provides information concerning the threat, such as a threat level, a recommended action, who to contact, or the like. For example, in response to determining that a collected fingerprint for subject 122a matches a fingerprint in local watchlist data 160 that is associated with “John Smith,” subject assessment module 144 may generate a subject threat alert with a message that states, “Current subject is named John Smith, has a high threat level, and a recommended action of detain” and cause the message to be presented by way of UI 134 of peer device 108a. As described, appropriate action may be taken based on the subject threat alert. For example, in response to receiving the message, soldier monitor 120a may prevent subject 122a from boarding transport vehicle 206 and detain subject 122a in field 202a. In some embodiments, following generating of a subject threat alert (block 342), method 300 may return to monitoring peer device status (block 302).

In some embodiments, determining whether subject verification data has been collected (block 310) includes determining whether subject data has been obtained, such as biometric data, biographic data, or other relevant data for use in verifying the status of individuals. For example, determining whether subject verification data has been collected may include a subject assessment module 144 of a peer device 108 determining whether subject data 121, including biometric data, biographic data, or other relevant data for use in verifying the status of individuals, has been received by way of a biometric sensor 155, a user interface 134, or the like of the peer device 108. Referencing FIG. 2, this may include, for example, where peer device 108a is present with soldier operator 120a that is active in verifying the status of individual subject 122a, soldier operator 120 selecting to initiate a verification operation of a screening application 138 running on peer device 108a. In response to initiation of the verification operation, subject assessment module 144 may initiate a biometric scan operation that includes requesting that soldier operator 120a acquire a fingerprint scan of the candidate subject by way of the onboard fingerprint scanner, enter biographic information for the candidate subject, and enter any other relevant information for the candidate subject. Soldier operator 120a may, in turn, acquire subject data 121, including a fingerprint scan of subject 122a using the onboard fingerprint scanner type biometric sensor 155 of peer device 108a, enter a name (“John Smith”) provided by subject 122a by way of UI 134 of peer device 108a, and enter notes regarding subject 122a (e.g., such as an apparent affiliation with a group of persons) by way of UI 134 of peer device 108a. In response to determining that subject verification data has not been collected (e.g., no initiation of a verification operation has occurred) (block 310—no), method 300 may include returning to monitoring peer device status (block 302).

In response to a selection to initiate the verification operation and acquisition of corresponding subject data 121, subject assessment module 144 may determine that subject verification data has been collected (block 310—yes) and proceed to determining whether the subject is verified (block 350). This may include comparing relevant parts of the subject data 121, such as collected biometrics of a subject 122, to corresponding access control data 118 or watchlist data 116. For example, determining whether a subject is verified may include comparing biometric data, such as a fingerprint, of subject data 121 for a subject 122 to biometric data contained in watchlist data 116, such as fingerprints associated with individuals identified in the watchlist data 116, to determine whether the subject 122 is considered a threat. Referencing FIG. 2, this may include, for example, where peer device 108a is being used to verify status of individual subject 122a and has collected a fingerprint scan of subject 122a using the onboard fingerprint scanner of peer device 108a, the subject assessment module 144 comparing the collected fingerprint to fingerprints contained in local watchlist data 160, determining that the collected fingerprint matches a fingerprint in local watchlist data 160 that is associated with “John Smith,” and, in response, determining that a threat exists. As another example, this may include, where peer device 108b is being used to verify the status of subject 122b and has collected a fingerprint scan of subject 122b using the onboard fingerprint scanner of peer device 108b, the subject assessment module 144 comparing the collected fingerprint to fingerprints contained in local watchlist data 160, determining that the collected fingerprint does not match a fingerprint in local watchlist data 160, and, in response, determining that a threat does not exist (e.g., subject 122b is not a threat). In some embodiments, determining whether a subject is verified may include determining whether the subject is authenticated. For example, determining whether the subject is verified may include comparing biometric data, such as a fingerprint, of subject data 121 for a subject 122 to biometric data contained in access control data 118, such as fingerprints associated with individuals identified in access control data 118, to determine whether the subject 122 is authenticated by the access control data 118. Referencing FIG. 2, this may include, for example, where peer device 108a is being used to verify the status of individual subject 122b and has collected a fingerprint scan of subject 122b using the onboard fingerprint scanner of peer device 108a, the subject assessment module 144 comparing the collected fingerprint to fingerprints contained in local access control data 162, determining that the collected fingerprint does match a fingerprint in local access control data 162 that is associated with “John Smith,” and, in response, determining that subject 122b is authenticated. As another example, this may include, where peer device 108b is being used to verify the status of subject 122c and has collected a fingerprint scan of subject 122c using the onboard fingerprint scanner of peer device 108b, the subject assessment module 144 comparing the collected fingerprint to fingerprints contained in local access control data 162, determining that the collected fingerprint does not match a fingerprint in local watchlist data 160, and, in response, determining subject 122c is not authenticated. In some embodiments, a subject 122 is determined to be verified when it is determined that the subject 122 is not a threat and the subject 122 is authenticated, and a subject 122 is determined to be not verified when it is determined that the subject 122 is a threat or the subject 122 is not authenticated.

In response to determining that a subject is not verified (block 350—no), method 300 may proceed to generating a subject threat alert (block 342). This may include providing an alert that provides information concerning the threat, such as a threat level, a recommended action, who to contact, or the like. For example, in response to determining that a collected fingerprint for subject 122a matches a fingerprint in local watchlist data 160 that is associated with “John Smith,” subject assessment module 144 may generate a subject threat alert with a message that states, “Current subject is named John Smith, has a high threat level, and a recommended action of detain” and cause the message to be presented by way of UI 134 of peer device 108a. Or, in response to determining that a collected fingerprint for subject 122c does not match a fingerprint in local access control data 162, subject assessment module 144 may generate a subject threat alert with a message that states, “Not Authenticated. This user is not recognized. Deny Access” and cause the message to be presented by way of UI 134 of peer device 108b. As described, appropriate action may be taken based on the subject threat alert. For example, in response to receiving the message, soldier monitor 120a may prevent subject 122a from boarding transport vehicle 206 and detain subject 122a in field 202a. In some embodiments, following generating of a subject threat alert (block 342), method 300 may return to monitoring peer device status (block 302).

In response to determining that a subject is verified (block 350—yes), method 300 may proceed to enabling access (block 351). This may include providing desired access to a given resource, such as access to transportation, a location, housing, data, employment, or the like. For example, in response to determining that a collected fingerprint for subject 122b does not match a fingerprint in local watchlist data 160, subject assessment module 144 may generate a subject message that states, “Current subject is not a threat match” and cause the message to be presented by way of UI 134 of peer device 108b. As described, appropriate action may be taken based on the no threat determination. For example, in response to receiving the message, soldier monitor 120b may allow subject 122b to board transport vehicle 206. In some embodiments, following enabling access (block 351), method 300 may proceed to generating an access control entry (block 344). This may include logging details of the interaction with a subject 120. For example, soldier 120b may, after allowing subject 122b to board transport vehicle 206, submit, by way of UI 134 of peer device 108a, a status entry that includes the fingerprint, name (John Doe) and other relevant information collected for subject 122b and indicates that subject 122b (John Doe) has boarded transport vehicle 206 bound for housing facility 202b, and access control data module 142 may generate a corresponding access control data entry 124 and update local access control data 162 of peer device 108a to include or otherwise reflect the generated access control data entry 124.

In some embodiments, method 300 includes, in response to generating an access control entry (block 344), proceeding to synchronize access control data with peer devices (block 348). This may include, for example, conducting a P2P synchronization operation to disseminate any new, un-synchronized access control entry with co-located peer devices 108. For example, referencing FIG. 2, in response to access control data module 142 of peer device 108a updating local access control data 162 of peer device 108a to include or otherwise reflect the status entry concerning John Smith, access control data module 142 may interact with access control data modules 142 of co-located peer devices 108b-108d to complete a synchronization that updates the local access control data 162 of some or all of peer devices 108b-108d to include or otherwise reflect the generated access control data entry 124 for John Smith. As another example, in response to access control data module 142 of peer device 108b updating local access control data 162 of peer device 108b to include or otherwise reflect the status entry concerning John Doe, access control data module 142 may interact with access control data modules 142 of co-located peer devices 108a, 108c and 108d to complete a synchronization that updates the local access control data 162 of some or all of peer devices 108a, 108c and 108d to include or otherwise reflect the generated access control data entry 124 concerning John Doe. In some embodiments, method 300 includes, in response to generating an access control entry (block 344), returning to monitoring peer device status (block 302).

In some embodiments, determining whether a network connection is available (block 314) includes determining whether a connection is available that provides for communication between the peer device 108 and ACS 112. For example, determining whether a network connection is available may include a communication module 146 of a peer device 108 determining whether it has an established connection with device network 106 that provides for communication with ACS controller 113 of ACS 112. Referencing FIG. 2, this may include, for example, where peer device 108a has generated, or otherwise has stored in local access control data 162, one or more new access control data entries 124 (e.g., for subject 122a), with communication module 146 monitoring its connection with device network 106 to determine whether it has an established connection with ACS controller 113. In response to determining that a network connection is not available (block 314—no) (e.g., communication module 146 determining that communication devices 152 of peer device 108 are not connected to the Internet), method 300 may include returning to monitoring peer device status (block 302). In response to determining that a network connection is available (block 314—yes) (e.g., communication module 146 determining that a communication device 152 of peer device 108 is connected to the Internet and ACS controller 113), method 300 may proceed to determining whether there is subject data available to export to a network device (block 352). This may include determining whether peer device 108a has generated, or otherwise has stored in local access control data 162, one or more access control data entries 124 that have not yet been provided to ACS 112. For example, if access control data module 142 of peer device 108a has generated a status entry concerning John Smith and updated local access control data 162 of peer device 108a to include or otherwise reflect an access control data entry 124 concerning John Smith, then access control data module 142 of peer device 108a may determine that there is subject data to be exported to a network device. If, for example, access control data module 142 of peer device 108a has not generated a “new” access control data entry 124 or otherwise updated local access control data 162 of peer device 108a, then access control data module 142 of peer device 108a may determine that there is no subject data to be exported to a network device.

In response to determining that there is no subject data to be exported to a network device (block 352—no), method 300 may include returning to monitoring peer device status (block 302). In response to determining that there is subject data to be exported to a network device (block 352—yes), method 300 may proceed to exporting subject data to a network device (block 354). This may include a peer device 108 uploading, to ACS controller 113 via device network 106, subject data to be exported. For example, access control data module 142 of the screening application of peer device 108a may initiate an upload of the “new” access control data entry 124 for subject 122a to ACS controller 113, which may in turn update access control data 118 to include or otherwise reflect the “new” access control data entry 124 for subject 122a. In response to exporting subject data to a network device (block 354), method 300 may include returning to monitoring peer device status (block 302).

In some embodiments, uploads of subject data by a given peer device 108 is limited to data, such as access control data entries 124, generated by that peer device 108, and may not include data, such as access control data entries 124 received by that peer device 108, such as by way of a synchronization operation. For example, referencing FIG. 2, when soldier monitor 120a and peer device 108a move into range of first access point 200a (e.g., after the subject check-in is complete), the access control data module 142 of the screening application of peer device 108a may initiate an upload of the “new” access control data entry 124 for subject 122a to ACS controller 113, which may, in turn, update access control data 118 stored on access control database 114 to include or otherwise reflect the access control data entry 124 for subject 122a. Such limited uploads may help to reduce redundant data being uploaded to ACS 112, which can, in turn, reduce conflicts and processing overhead, and associated errors.

In some embodiments, determining whether updated peer access control data is available (block 312) includes communicating with a peer to determine whether a peer has updated access control data to be synchronized. For example, determining whether updated peer access control data is available may include an access control data module 142 of a peer device 108 querying another peer device 108 for an updated set of access control data 118. Referencing FIG. 2, this may include, for example, in response to communication module 146 of peer device 108a providing an indication that peer device 108a is connected to peer device 108b, access control data module 142 of peer device 108a querying access control data module 142 of peer device 108b for any updates to local access control data 162 of peer device 108b that are not yet reflected in local access control data 162 of peer device 108a.

In response to an indication that no updated peer access control data is available (block 312—no), method 300 may include returning to monitoring peer device status (block 302). For example, in response to access control data module 142 of peer device 108a receiving from access control data module 142 of peer device 108b in response to a query for updates to access control data, an indication that no updated (or “new”) peer access control data 118 is available, returning to monitoring peer device status (block 302). In some embodiments, determining whether updated peer access control data is available is conducted periodically to maintain local access control data 162 with a current listing of access control data 118. For example, in response to being connected to one or more peer devices 108, access control data module 142 of peer device 108a may periodically (e.g., every 0.1 seconds (sec), 0.5 sec, 1 sec, 5 sec, 10 sec, 30 sec, 1 min, or the like) submit, to a directly connected peer device 108, a query for updates to the set of local access control data 162.

In response to an indication that updated peer access control data is available (block 312—yes), method 300 may proceed to importing updated peer access control data via a network (block 360). For example, in response to access control data module 142 of peer device 108a receiving, from access control data module 142 of peer device 108b in response to a query for updates to the set of local access control data 162, an indication that updated (or “new”) peer access control data 118 is available, access control data module 142 of peer device 108a may proceed to obtain, from access control data module 142 of peer device 108b via P2P network 104 (e.g., via a direct Peer-to-Peer Wi-Fi connection between peer devices 108a and 108b), updated peer access control data 118. Referencing FIG. 2, this may include, for example, access control data module 142 of peer device 108a downloading from access control data module 142 of peer device 108b, “new” access control data 118 (e.g., including any “new” access control data entries 124) and updating local access control data 162 stored in a memory of peer device 108a to reflect the updates included in the access control data 118 exchanged.

In some embodiments, method 300 includes synchronizing watchlist data with peer devices (block 332). This may include, in response to obtaining updated access control data 118, conducting a peer-to-peer synchronization to synchronize the updated peer access control data 118 across other co-located peer devices 108. Referencing FIG. 2, this may include, for example, in response to access control data module 142 of peer device 108a receiving from access control data module 142 of peer device 108b, updated access control data 118 that includes new entries for subject 122d (Mike James), conducting a P2P synchronization operation to disseminate updated access control data 118 that includes the “new” access control data entry 124 for subject 122a (Mike James) to each of other peer devices 108b-108d, so they, in turn, update their local access control data 162 to reflect the updated access control data 118 that includes the new access control data entry 124 for subject 122d (Mike James). Method 300 may include, upon completion of synchronizing access control data with peer devices (block 362), returning to monitoring peer device status (block 302).

FIG. 4 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random-access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to one or more of the entities described (e.g., watchlist data source 110, access control system 112, peer devices 108), or one or more of the operations described (e.g., operations of method 300).

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each includes a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display/touch screen (e.g., an electronic display for displaying a graphical user interface (GUI)). The I/O devices 1014 may include one or more of the user-input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers, or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here; parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). As used throughout this application, the term “to” does not limit the associated operation to being directly to. Thus, for example, transmitting an item “to” an entity may include transmitting an item directly to the entity or indirectly to the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic, or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. An individual monitoring system comprising:
a watchlist data source configured to maintain a watchlist comprising watchlist data concerning individuals of interest, the watchlist data comprising respective sets of biometric characteristics associated with respective individuals of the individuals of interest;
an access control system configured to maintain access control data concerning monitored individuals, the access control data comprising respective sets of subject data associated with respective individuals of the monitored individuals, the sets of subject data comprising biometric characteristics and biographic characteristics of monitored individuals; and
two or more peer devices configured to communicate with one another by way of peer-to-peer communication, each of the peer devices associated with an operator, comprising a biometric sensor, and configured to perform the following operations:
obtain, from the watchlist data source by way of a client-server communications network, first watchlist data concerning a first set of individuals of interest, the first watchlist data comprising respective sets of biometric characteristics associated with respective individuals of the first set of individuals of interest;
obtain, by way of the biometric sensor of the peer device, first biometric data for a first individual;
determine, based on comparison of the first biometric data for the first individual to the biometric characteristics of the first watchlist data, a first threat level for the first individual;
provide an indication of the first threat level for the first individual;
generate a first access control data entry for the first individual, the first access control data entry for the first individual comprising an indication of the first biometric data for the first individual;
send, to one or more other of the peer devices by way of peer-to-peer synchronization with the one or more other of the peer devices, first access control data comprising the first access control data entry for the first individual;
send, to the access control system in response to determining a connection with the access control system and by way of a client-server communication network, the first access control data entry for the first individual;
receive, by way of peer-to-peer synchronization with one or more other of the peer devices, second access control data; and
receive, by way of peer-to-peer synchronization with one or more other of the peer devices, second watchlist data.

2. The system of claim 1, wherein the watchlist comprises a biometrics-enabled watchlist (BEWL), and the first watchlist data corresponds to at least a portion of the BEWL.

3. The system of claim 1, wherein the peer-to-peer synchronization between peer devices comprises:
transmitting, by a receiving peer device to a sending peer device, a query for data; and
transmitting, by the sending peer device to the receiving peer device responsive to the query, data.

4. The system of claim 1, wherein the peer device comprises a mobile communications device and the peer-to-peer synchronization with one or more other of the peer devices is accomplished by way of wireless communication.

5. The system of claim 1, wherein the peer-to-peer synchronization of data between peer devices is accomplished without transmission of the data to a server of a client-server-based communications network.

6. The system of claim 1, wherein the watchlist data source comprises a database comprising the watchlist, and wherein the access control system comprises a database comprising access control data entries and configured to store, in the database, data corresponding to the first access control data entry for the first individual.

7. The system of claim 1, wherein the indication of the first threat level for the first individual comprises an action to be taken by a first operator associated with the peer device.

8. The system of claim 7, wherein the action to be taken comprises detaining the first individual.

9. The system of claim 7, wherein the action to be taken comprises providing the first individual with access to one or more resources or opportunities.

10. A method for monitoring individuals, comprising:
obtaining, by a peer device from a watchlist data source by way of a client-server communications network, first watchlist data concerning a first set of individuals of interest, the watchlist data source maintaining a watchlist comprising watchlist data concerning individuals of interest, the watchlist data comprising respective sets of biometric characteristics associated with respective individuals of the individuals of interest, the first watchlist data comprising respective sets of biometric characteristics associated with respective individuals of the first set of individuals of interest, communicating, the peer device configured to communicate with other peer devices by way of peer-to-peer communication, the peer device associated with an operator, comprising a biometric sensor;
obtaining, by the peer device by way of the biometric sensor of the peer device, first biometric data for a first individual;
determining, by the peer device based on comparison of the first biometric data for the first individual to the biometric characteristics of the first watchlist data, a first threat level for the first individual;
providing, by the peer device, an indication of the first threat level for the first individual;
generating, by the peer device, a first access control data entry for the first individual, the first access control data entry for the first individual comprising an indication of the first biometric data for the first individual;
sending, by the peer device to one or more other of the peer devices by way of peer-to-peer synchronization with the one or more other of the peer devices, first access control data comprising the first access control data entry for the first individual;
sending, by the peer device to an access control system in response to determining a connection with the access control system and by way of a client-server communication network, the first access control data entry for the first individual, the access control system configured to maintain access control data concerning monitored individuals, the access control data comprising respective sets of subject data associated with respective individuals of the monitored individuals, the sets of subject data comprising biometric characteristics and biographic characteristics of monitored individuals; and
receiving, by the peer device by way of peer-to-peer synchronization with one or more other of the peer devices, second access control data; and
receiving, by the peer device by way of peer-to-peer synchronization with one or more other of the peer devices, second watchlist data.

11. The method of claim 10, wherein the watchlist comprises a biometrically enabled watchlist (BEWL), and the first watchlist data corresponds to at least a portion of the BEWL.

12. The method of claim 10, wherein the peer-to-peer synchronization between peer devices comprises:
transmitting, by a receiving peer device to a sending peer device, a query for data; and
transmitting, by the sending peer device to the receiving peer device responsive to the query, data.

13. The method of claim 10, wherein the peer device comprises a mobile communications device and the peer-to-peer synchronization with one or more other of the peer devices is accomplished by way of wireless communication.

14. The method of claim 10, wherein the peer-to-peer synchronization of data between peer devices is accomplished without transmission of the data to a server of a client-server-based communications network.

15. The method of claim 10, wherein the watchlist data source comprises a database comprising the watchlist, and wherein the access control system comprises a database comprising access control data entries and configured to store, in the database, data corresponding to the first access control data entry for the first individual.

16. The method of claim 10, wherein the indication of the first threat level for the first individual comprises an action to be taken by a first operator associated with the peer device.

17. The method of claim 16, wherein the action to be taken comprises detaining the first individual.

18. The method of claim 16, wherein the action to be taken comprises providing the first individual with access to one or more resources or opportunities.

19. A non-transitory computer readable storage medium comprising program instructions stored thereon that are executable by a processor to cause the following operations for monitoring individuals:
obtaining, by a peer device from a watchlist data source by way of a client-server communications network, first watchlist data concerning a first set of individuals of interest, the watchlist data source maintaining a watchlist comprising watchlist data concerning individuals of interest, the watchlist data comprising respective sets of biometric characteristics associated with respective individuals of the individuals of interest, the first watchlist data comprising respective sets of biometric characteristics associated with respective individuals of the first set of individuals of interest, communicating, the peer device configured to communicate with other peer devices by way of peer-to-peer communication, the peer device associated with an operator, comprising a biometric sensor;
obtaining, by the peer device by way of the biometric sensor of the peer device, first biometric data for a first individual;
determining, by the peer device based on comparison of the first biometric data for the first individual to the biometric characteristics of the first watchlist data, a first threat level for the first individual;
providing, by the peer device, an indication of the first threat level for the first individual;
generating, by the peer device, a first access control data entry for the first individual, the first access control data entry for the first individual comprising an indication of the first biometric data for the first individual;
sending, by the peer device to one or more other of the peer devices by way of peer-to-peer synchronization with the one or more other of the peer devices, first access control data comprising the first access control data entry for the first individual;
sending, by the peer device to an access control system in response to determining a connection with the access control system and by way of a client-server communication network, the first access control data entry for the first individual, the access control system configured to maintain access control data concerning monitored individuals, the access control data comprising respective sets of subject data associated with respective individuals of the monitored individuals, the sets of subject data comprising biometric characteristics and biographic characteristics of monitored individuals; and
receiving, by the peer device by way of peer-to-peer synchronization with one or more other of the peer devices, second access control data; and
receiving, by the peer device by way of peer-to-peer synchronization with one or more other of the peer devices, second watchlist data.

20. A system for monitoring individuals, comprising:
a peer device configured to perform the following operations:
obtaining, from a watchlist data source, first watchlist data concerning a first set of individuals of interest, the first watchlist data comprising biometric characteristics for the first set of individuals of interest;
obtaining, by way of a biometric sensor of the peer device, first biometric data for a first individual;
determining, based on comparison of the first biometric data for the first individual to the biometric characteristics of the first watchlist data, a first threat level for the first individual;
generating, a first access control data entry for the first individual, the first access control data entry for the first individual comprising an indication of the first biometric data for the first individual;
sending, to one or more other of the peer devices by way of peer-to-peer synchronization with the one or more other of the peer devices, first access control data comprising the first access control data entry for the first individual; and
sending, to an access control system, the first access control data entry for the first individual.
